(19) United States
(12) Patent Application Publication
(10) Pub. No.: US 2026/0042084 A1
(43) Pub. Date: Feb. 12, 2026

(54) SORBENTS FUNCTIONALIZED WITH LIGANDS HAVING AN AMINOSILICONE FUNCTIONAL GROUP

(71) Applicant: GENERAL ELECTRIC TECHNOLOGY GMBH, Baden (CH)

(72) Inventors: Mark D. DOHERTY, Niskayuna, NY (US); Michael Joseph O'BRIEN, Niskayuna, NY (US); Jingjing YANG, Niskayuna, NY (US); Robert E. COLBORN, Niskayuna, NY (US); David MOORE, Niskayuna, NY (US); Bryce Martin LIPINSKI, Niskayuna, NY (US); Jie Jerry LIU, Niskayuna, NY (US); Alexandra ANTONIO, Niskayuna, NY (US); Anil R. DUGGAL, Niskayuna, NY (US); Robert James PERRY, Niskayuna, NY (US); Maya CHAABAN, Niskayuna, NY (US)

(21) Appl. No.: 19/104,921

(22) PCT Filed: Jan. 10, 2023
(86) PCT No.: PCT/US2023/060396

§ 371 Date: Feb. 19, 2025

Related U.S. Application Data
(60) Provisional application No. 63/399,251, filed on Aug. 19, 2022.
(60) Provisional application No. 63/386,231, filed on Dec. 6, 2022.

(51) Int. Cl. B01J 20/32; B01D 53/62; B01D 53/81; B01J 20/22

(52) U.S. Cl. CPC B01J 20/3219; B01D 53/62; B01D 53/81; B01J 20/226; B01J 20/3208; B01J 20/3259; B01J 20/3285; B01D 2253/204; B01D 2253/25; B01D 2257/504

(57) ABSTRACT

Described herein are sorbents functionalized with ligands having an aminosilicone functional group. Also described herein are methods of making the sorbents functionalized with ligands having an aminosilicone functional group. Also described herein are methods of using the sorbents functionalized with ligands having an aminosilicone functional group.

### RELATED APPLICATIONS

This application claims priority to U.S. Provisional Application Ser. No. 63/399,251, filed on Aug. 19, 2022, and also claims priority to U.S. Provisional Application Ser. No. 63/386,231, filed on Dec. 6, 2022, the contents of which are hereby incorporated by reference in their entirety.

### BACKGROUND

The field of the disclosure relates generally to sorbents functionalized with ligands having an aminosilicone functional group, methods of making same, and methods of using same.

Solid sorbents are useful for a wide variety of purposes. For example, they are particularly useful in carbon capture sorbent systems, such as for use in point source, post-combustion and direct air capture of CO₂.

Solid sorbents used in carbon capture offer a viable and superior techno-economic alternative to conventional liquid-amine based CO₂ capture processes. For example, solid sorbents tend to have better adsorption capacity, lower regeneration energy requirements, and reduced system complexity and environmental and safety risks as compared to active liquid amines.

There are two types of sorbent materials based on their underlying adsorption mechanisms. A first type, physisorbents, rely on non-covalent interactions (e.g., van der Waals interactions, dipole-dipole interactions, etc.) to adsorb gaseous species such as CO₂ and H₂O. Examples of physisorbents include activated carbon, zeolites, and metal-organic frameworks (MOF). A second type, chemisorbents, adsorb CO₂ through reversible chemical reactions and through the formation of ammonium carbamate, carbamic acid, ammonium carbonate, and/or ammonium bicarbonate. Examples of chemisorbents include amine-functionalized silica particles, amine-functionalized polymers and resins, amine-functionalized metal-organic frameworks (MOF), and amine-functionalized covalent organic frameworks (COF).

As a result of chemical bonding, chemisorbent materials generally have superior selectivity of CO₂ adsorption as compared to physisorbent materials for interfering species like N₂, methane, and CO. However, the effectiveness of chemisorbent systems may be limited by the compositional nature of the functionalizing molecules performing the chemisorption and the functionalization process. Accordingly, there is a need for functionalized sorbents that contain chemically- and thermally-stable molecular species that selectively uptake CO₂ with high capacities and rapid kinetics.

### BRIEF DESCRIPTION

In one aspect, a functionalized sorbent is provided. The functionalized sorbent includes a sorbent and at least one functionalization ligand including an aminosilicone group.

In another aspect, a method of making a functionalized sorbent is provided. The method includes: (I) forming a mixture including a sorbent, at least one functionalization ligand including an aminosilicone group, optionally at least one functionalization ligand not including an aminosilicone group, optionally a solvent; and optionally a non-solvent; and (II) functionalizing the sorbent.

In another aspect, a method of capturing at least one gas is provided. The method includes: (I) receiving a gas source including the at least one gas at a functionalized sorbent, wherein the functionalized sorbent includes a sorbent and at least one functionalization ligand including an aminosilicone group; and (II) capturing an amount of the at least one gas with the functionalized sorbent.

In another aspect, a method of collecting at least one gas is provided. The method includes: (I) receiving a gas source including the at least one gas at a functionalized sorbent, wherein the functionalized sorbent includes a sorbent and at least one functionalization ligand including an aminosilicone group; (II) capturing an amount of the at least one gas with the functionalized sorbent; and (III) releasing the at least one gas from the functionalized sorbent.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an exemplary method flow chart in accordance with the present disclosure;

FIG. 2 is an exemplary method flow chart in accordance with the present disclosure;

FIG. 3 is an exemplary method flow chart in accordance with the present disclosure;

FIG. 4 illustrates the potential CO₂ capacity of MOF compounds functionalized with pure AEAM, pure spermine, or hybrid amines (spermine and AEAM) measured at 4.5% (v/v) CO₂ concentration, 60° C., and 30% RH in accordance with the present disclosure;

FIG. 5 illustrates the potential CO₂ capacity of MOF compounds functionalized with pure AEAM, pure spermine, or hybrid amines (spermine and AEAM) measured at 400 ppmv CO₂ concentration, 25° C., and 30% RH in accordance with the present disclosure;

FIG. 6 illustrates the potential CO₂ productivity of MOF compounds functionalized with pure AEAM, pure spermine, or hybrid amines (spermine and AEAM) measured at 4.5% (v/v) CO₂ concentration, 60° C., and 30% RH in accordance with the present disclosure;

FIG. 7 illustrates the potential CO₂ productivity of MOF compounds functionalized with pure AEAM, pure spermine, or hybrid amines (spermine and AEAM) measured at 400 ppmv CO₂ concentration, 25° C., and 30% RH in accordance with the present disclosure;

FIG. 8 depicts dry CO₂ isotherms for MOF compounds functionalized with pure spermine or hybrid amines (spermine and AEAM) in accordance with the present disclosure;

FIG. 9 illustrates the potential CO₂ capacity of MOF compounds functionalized with pure AEAM, pure spermidine, or hybrid amines (spermidine and AEAM) measured at 4.5% (v/v) CO₂ concentration, 60° C., and 30% RH in accordance with the present disclosure;

FIG. 10 illustrates the potential CO₂ productivity at 15 minutes of MOF compounds functionalized with pure AEAM, pure spermidine, or hybrid amines (spermidine and AEAM) measured at 4.5% (v/v) CO₂ concentration, 60° C., and 30% RH in accordance with the present disclosure; and

FIG. 11 illustrates the potential H₂O/CO₂ ratios of MOF compounds functionalized with pure AEAM, pure spermidine, or hybrid amines (spermidine and AEAM) measured at 4.5% (v/v) CO₂ concentration, 60° C., and 30% RH in accordance with the present disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The embodiments described herein overcome at least some of the disadvantages of known sorbents. The exemplary embodiments described herein include a functionalized sorbent. The functionalized sorbent includes a sorbent and at least one functionalization ligand that includes an aminosilicone group. The exemplary embodiments described herein facilitate significantly enhanced CO₂ capacity and CO₂ productivity as compared to known sorbents. The exemplary embodiments described herein also facilitate significantly improved uptake of CO₂ relative to uptake of H₂O.

In some embodiments, the functionalized sorbent includes a first type of functionalization ligand, wherein the first type of functionalization ligand includes at least one functionalization ligand that includes an aminosilicone group. Generally, the at least one functionalization ligand that includes an aminosilicone group may include any such suitable ligand that facilitates the functionalized sorbent described herein. The at least one functionalization ligand that includes an aminosilicone group may include only one functionalization ligand that includes an aminosilicone group or two or more functionalization ligands that each include an aminosilicone group.

Generally, the sorbent may be any suitable sorbent known in the art that facilitates the functionalized sorbent described herein. In some embodiments, the sorbent is selected from the group consisting of coordination framework compounds, metal-organic framework (MOF) compounds, porous coordination polymers (PCPs), covalent organic framework (COF) compounds, zeolitic imidazolate framework (ZIF) compounds, crystalline porous materials, crystalline open frameworks, reticular chemistry, silica particles, zeolites, silico-alumino-phosphates (SAPOs), alumino-phosphates (AlPOs), polyaromatic frameworks (PAFs), activated carbons, molecular organic solids, and combinations thereof.

As used herein, MOF compounds are a class of compounds including metal ions or clusters coordinated to organic ligands to form one-, two-, or three-dimensional structures. The metal ions or clusters act as joints and are bound by multidirectional organic ligands, which act as linkers in a network structure. MOF compounds have a modular nature that allows for synthetic tunability, which affords fine chemical and structural control. Properties such as porosity, stability, particle morphology, and conductivity can be tailored for specific applications.

In many embodiments, the sorbent is a MOF compound including a MOF metal or metal-containing cluster and a MOF linker.

In some embodiments, the MOF metal may be any suitable MOF metal known in the art that facilitates the functionalized sorbent described herein. In other embodiments, the MOF metal is a metal selected from the group consisting of alkali metals, alkaline earth metals, transition metals, Ca, Mn, Cr, Fe, Co, Ni, Cu, Zn, ions thereof, hydrates thereof, salts thereof, halides thereof, fluorides thereof, chlorides thereof, bromides thereof, iodides thereof, nitrates thereof, acetates thereof, sulfates thereof, phosphates thereof, carbonates thereof, oxides thereof, formates thereof, carboxylates thereof, and combinations thereof. In some embodiments, the MOF metal includes Mg.

In some embodiments, the MOF metal-containing cluster may be any suitable MOF metal-containing cluster known in the art that facilitates the functionalized sorbent described herein. In some embodiments, the MOF metal-containing cluster includes an MOF metal node and a linker strut, with the MOF metal and the linker each defined as described herein. In other embodiments, the MOF metal-containing cluster includes an MOF metal-oxy cluster.

In some embodiments, the MOF linker may be any suitable MOF linker known in the art that facilitates the functionalized sorbent described herein. Generally, the geometry and connectivity of a linker contribute to the structure of the resulting MOF compound. Adjustments of linker geometry, length, ratio, and functional-group can tune the size, shape, and internal surface property of a MOF compound for a targeted application.

In at least some embodiments, the MOF linker is a linker selected from the group consisting of polytopic linkers, ditopic linkers, tritopic linkers, tetratopic linkers, pentatopic linkers, hexatopic linkers, heptatopic linkers, octatopic linkers, mixed linkers, desymmetrized linker, metallo linkers, N-heterocyclic linkers, and combinations thereof.

In at least some embodiments, the MOF linker is a linker selected from the group consisting of polytopic linkers, 4,4′-dihydroxy-[1,1′-biphenyl]-3,3′-dicarboxylic acid (H₄dobpdc), 4,4′-dioxidobiphenyl-3,3′-dicarboxylate (dobpdc⁴⁻), 4,4″-dioxido-[1,1′:4′,1″-terphenyl]-3,3″-dicarboxylate (dotpdc⁴⁻), 2,5-dioxidobenzene-1,4-dicarboxylate (dobdc⁴⁻), 4,6-Dihydroxyisophthalic acid (m-dobdc⁴⁻), 3,3′-dioxido-biphenyl-4,4′-dicarboxylate (para-carboxylate-dobpdc⁴⁻), 4,4′-[oxalylbis(imino)]bis(2-hydroxybenzoic acid) (H₄ODA), 4,4′-[1,4-phenylenebis-(carbonylimino)]bis(2-hydroxybenzoic acid) (H₄TDA), 4,4′-Dihydroxyazobenzene-3,3′-dicarboxylic acid (H₄OSA), protonated, partially and fully deprotonated forms thereof, and combinations thereof. As another example, in at least some embodiments, the MOF linker is a linker selected from the group consisting of dicarboxylates (e.g., terephthalic acid), tricarboxylates (e.g., 1,3,5-benzentricarboxylic acid), azolates, tetrazolates, and combinations thereof.

As another example, in at least some embodiments, the MOF linker is a dicarboxylic acid linker selected from the group consisting of 1,4-butanedicarboxylic acid, 4-oxopyran-2,6-dicarboxylic acid. 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octanedicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis-(phenylamino)benzene-2,5-dicarboxylic acid, 1,1′-dinaphthyl-8,8′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro) phenylpyrazoline-4,5-dicarboxylic acid, 1,4,5,6,7,7,-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cisdicarboxylic acid, 2,2′-biquinoline-4,4′-dicarboxylic acid, pyridine-3,4-dicarboxylic acid, 3,6,9-trioxaundecanedicarboxylic acid, o-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyletherdiimidedicarboxylic acid, 4,4′-diaminodiphenylmethanediimidedicarboxylic acid, 4,4′-diaminodiphenylsulfonediimidedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′-3′-diphenyl-p-terphenyl-4,4″-dicarboxylic acid, diphenylether-4,4′-dicarboxylic acid, imidazole-4,5-dicarboxylic acid, 4(1H)-oxothiochromene-2,8-dicarboxylic acid, 5-t-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptanedicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, and combinations thereof.

As another example, in at least some embodiments, the MOF linker is a tricarboxylic acid linker selected from the group consisting of 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, aurinetricarboxylic acid, and combinations thereof.

As another example, in at least some embodiments, the MOF linker is a tetracarboxylic acid linker selected from the group consisting of 1,1-dioxide-perylo[1,12-BCD]thiophene-3,4,9,10-tetracarboxylic acid, perylenetetracarboxylic acids, perylene-3,4,9,10-tetracarboxylic acid, perylene-1,12-sulfone-3,4,9,10-tetracarboxylic acid, butanetetracarboxylic acids, 1,2,3,4-butanetetracarboxylic acid, meso-1,2,3,4-butanetetracarboxylic acid, decane-2,4,6,8-tetracarboxylic acid. 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, cyclopentanetetracarboxylic acids, cyclopentane-1,2,3,4-tetracarboxylic acid, and combinations thereof.

In the exemplary embodiment, the MOF linker is 4,4′-dihydroxy-[1,1′-biphenyl]-3,3′-dicarboxylic acid (H₄dobpdc) and/or 4,4′-dioxidobiphenyl-3,3′-dicarboxylate (dobpdc⁴⁻). In some embodiments, dobpdc includes 4,4′-dihydroxy-[1,1′-biphenyl]-3,3′-dicarboxylic acid, its mono-carboxylate form, its di-carboxylate form, its mono-phenoxide form, its di-phenoxide form, and combinations thereof.

In some embodiments, the MOF linker is one or more of the following linkers:

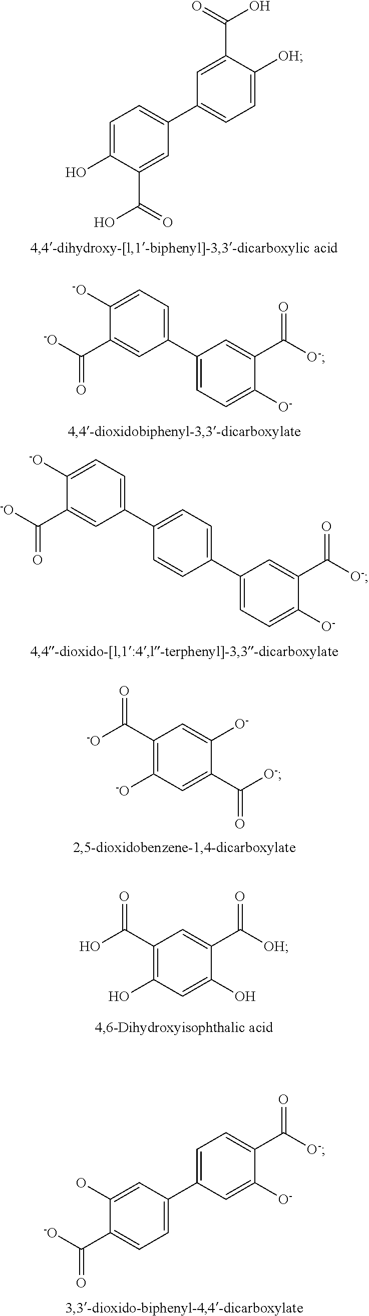

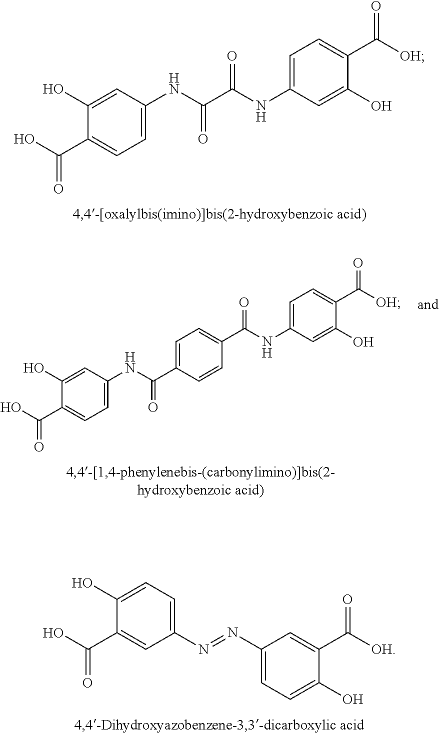 [SMILES: O=C(Nc1ccc(C(=O)O)c(O)c1)C(=O)Nc1ccc(C(=O)O)c(O)c1 ; O=C(Nc1ccc(C(=O)O)c(O)c1)c1ccc(C(=O)Nc2ccc(C(=O)O)c(O)c2)cc1 ; O=C(O)c1cc(/N=N/c2ccc(O)c(C(=O)O)c2)ccc1O]

In some embodiments, the MOF compound is a MOF compound of the MOF-74 family. In some embodiments, the MOF compound is a MOF compound of the MOF-303 family. In some embodiments, the MOF compound is Mg₂(dobpdc).

In some embodiments, the functionalized sorbent is a functionalized MOF compound of Formula (I)

$${M}_{x} {L}_{y} {F}_{a}^{A} {F}_{b}^{B} , \qquad ( Formula I )$$

wherein:
M is a MOF metal or metal-containing cluster;
L is a MOF linker;
F^{A} is at least one functionalization ligand comprising an aminosilicone group;
F^{B} is at least one functionalization ligand not comprising an aminosilicone group;
x is a value in a range of 1 to 6;
y is a value in a range of 1 to 6;
a is a value greater than 0 and less than or equal to 2; and
b is a value in a range of 0 to 2.

In some embodiments, the functionalized sorbent includes a second type of functionalization ligand, wherein the second type of functionalization ligand includes at least one functionalization ligand that does not include an aminosilicone group. In some embodiments, the functionalized sorbent also includes at least one functionalization ligand that does not include an aminosilicone group. Generally, the at least one functionalization ligand that does not include an aminosilicone group may include any such suitable ligand that facilitates the functionalized sorbent described herein. The at least one functionalization ligand that does not include an aminosilicone group may include only one functionalization ligand that does not include an aminosilicone group or two or more functionalization ligands that each do not include an aminosilicone group.

In some embodiments, the at least one functionalization ligand that does not include an aminosilicone group is selected from the group consisting of amine ligands, monoamine ligands, diamine ligands, triamine ligands, tetra-amine ligands, penta-amine ligands, hexa-amine ligands, polyamine ligands, alkylamine ligands, and amino-alcohol ligands. Exemplary ligands include, but are not limited to, ethylene diamine, N-methylethylenediamine, N-ethylethylenediamine, N,N-dimethylethylenediamine, N,N-diethylethylenediamine, di(N-methyl)ethylene diamine, N-isopropylethylenediamine, N,N-dimethyl-N-methylethylene diamine, di(N,N-dimethyl)ethylene diamine, N,N-diisopropylethylene diamine, 2,2-dimethyl-1,3-diaminopropane, 1,3-diaminopentane, diethylenetriamine, N-(2-aminoethyl)-1,3-propanediamine, bis(3-aminopropyl)amine, N-(3-aminopropyl)-1,4-diaminobutane (spermidine), triethylenetetramine, N,N′-bis(2-aminoethyl)-1,3-propanediamine, 1,2-bis(3-aminopropylamino)ethane, N,N′-bis(3-aminopropyl)-1,3-propanediamine, N,N′-bis(3-aminopropyl)-1,4-diaminobutane (spermine), tetraethylenepentamine, and/or combinations thereof.

Generally, the at least one functionalization ligand including an aminosilicone group and the at least one functionalization ligand not including an aminosilicone group may be present in any suitable ratio known in the art that facilitates the functionalized sorbent described herein. In some embodiments, the ratio is selected from the group consisting of a molar ratio, a weight ratio, and a volume ratio. In some embodiments, the at least one functionalization ligand including an aminosilicone group and the at least one functionalization ligand not including an aminosilicone group are present in a ratio in a range of from about 10:1 to about 1:10. In some embodiments, the at least one functionalization ligand including an aminosilicone group and the at least one functionalization ligand not including an aminosilicone group are present in a ratio in a range of from about 9:1 to about 1:9. In some embodiments, the at least one functionalization ligand including an aminosilicone group and the at least one functionalization ligand not including an aminosilicone group are present in a ratio in a range of from about 8:1 to about 1:8. In some embodiments, the at least one functionalization ligand including an aminosilicone group and the at least one functionalization ligand not including an aminosilicone group are present in a ratio in a range of from about 7:1 to about 1:7. In some embodiments, the at least one functionalization ligand including an aminosilicone group and the at least one functionalization ligand not including an aminosilicone group are present in a ratio in a range of from about 6:1 to about 1:6. In some embodiments, the at least one functionalization ligand including an aminosilicone group and the at least one functionalization ligand not including an aminosilicone group are present in a ratio in a range of from about 5:1 to about 1:5. In some embodiments, the at least one functionalization ligand including an aminosilicone group and the at least one functionalization ligand not including an aminosilicone group are present in a ratio in a range of from about 4:1 to about 1:4. In some embodiments, the at least one functionalization ligand including an aminosilicone group and the at least one functionalization ligand not including an aminosilicone group are present in a ratio in a range of from about 3:1 to about 1:3. In some embodiments, the at least one functionalization ligand including an aminosilicone group and the at least one functionalization ligand not including an aminosilicone group are present in a ratio in a range of from about 2:1 to about 1:2. In some embodiments, the at least one functionalization ligand including an aminosilicone group and the at least one functionalization ligand not including an aminosilicone group are present in a ratio of about 1:1.

In some embodiments, the at least one functionalization ligand including an aminosilicone group is present in a lesser amount than the at least one functionalization ligand not including an aminosilicone group.

In some embodiments, the at least one functionalization ligand including an aminosilicone group and the at least one functionalization ligand not including an aminosilicone group are present in a ratio of about 1:2, about 1:3, about 1:4, about 1:5, about 1:6, about 1:7, about 1:8, about 1:9, or about 1:10.

In many embodiments, the at least one functionalization ligand including an aminosilicone group may be any suitable at least one functionalization ligand including an aminosilicone group known in the art that facilitates the functionalized sorbent described herein.

In some embodiments, the at least one functionalization ligand including an aminosilicone group includes at least one amine selected from the group consisting of primary amines, secondary amines, tertiary amines, and combinations thereof. In some embodiments, the at least one functionalization ligand including an aminosilicone group includes at least one primary amine or at least one secondary amine.

In some embodiments, the at least one functionalization ligand including an aminosilicone group includes at least one amine selected from the group consisting of monoamines, diamines, triamines, tetra-amines, penta-amines, hexa-amines, polyamines, and combinations thereof.

In some embodiments, the at least one functionalization ligand including an aminosilicone group includes at least one aminosilicone selected from the group consisting of linear aminosilicones, cyclic aminosilicones, branched aminosilicones, amino-substituted siloxanes, linear amino-substituted disiloxanes, cyclic amino-substituted disiloxanes, linear amino-substituted trisiloxanes, cyclic amino-substituted trisiloxanes, linear amino-substituted tetrasiloxanes, cyclic amino-substituted tetrasiloxanes, linear amino-substituted polysiloxanes, cyclic amino-substituted polysiloxanes, silsesquioxanes, polyoctahedral silsesquioxanes, and combinations thereof.

In some embodiments, the at least one functionalization ligand including an aminosilicone group includes a symmetrical structure. In some embodiments, the at least one functionalization ligand including an aminosilicone group includes an asymmetrical structure.

In some embodiments, when the at least one functionalization ligand including an aminosilicone group includes a disiloxane group, the at least one functionalization ligand including an aminosilicone group includes the same amines on both sides of the disiloxane group. In some embodiments, when the at least one functionalization ligand including an aminosilicone group includes a disiloxane group, the at least one functionalization ligand including an aminosilicone group includes different amines on either side of the disiloxane group.

In some embodiments, the at least one functionalization ligand including an aminosilicone group is an amino-substituted siloxane of Formula (II), Formula (III), Formula (IV), Formula (V), Formula (VI), or Formula (VII)

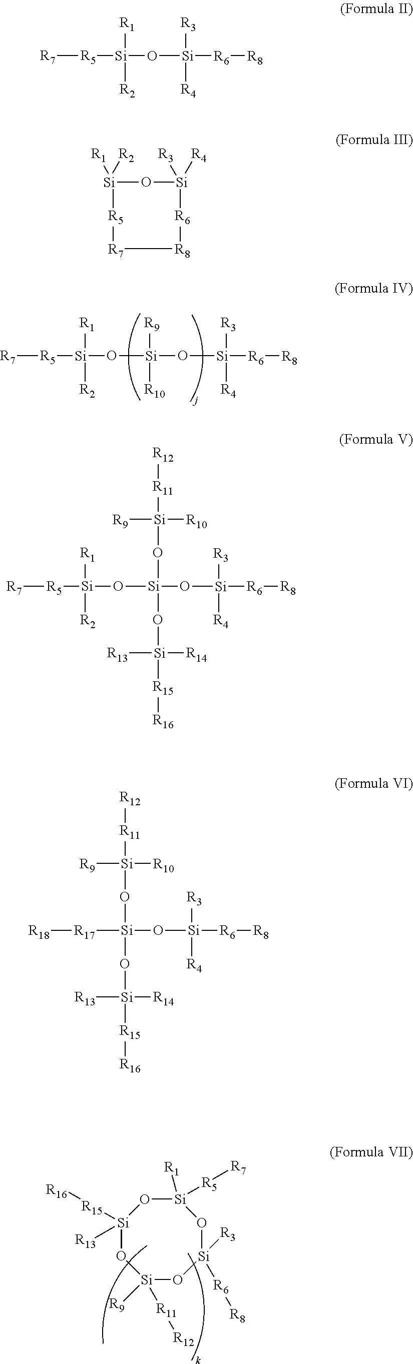

wherein:
R₁, R₂, R₃, R₄, R₉, R₁₀, R₁₃, R₁₄, and R₁₈ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₅, R₆, R₁₁, R₁₅, and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl,
R₇, R₈, R₁₂, and R₁₆ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, and substituents of Formula (VIII)

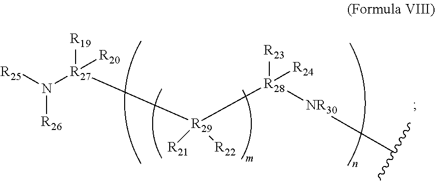

wherein:
the wavy bond indicates a bonding location to Formula (II) or Formula (III) or Formula (IV) or Formula (V) or Formula (VI) or Formula (VII);
R₁₉, R₂₀, R₂₁, R₂₂, R₂₃, and R₂₄ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₂₅ and R₂₆ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₂₅ and R₂₆ form a single ring selected from the group consisting of heterocycloalkyl and heteroaryl;
R₂₇, R₂₈, and R₂₉ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₀ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl;
j is an integer in a range of 0 to 20;
k is an integer in a range of 0 to 20;
m is an integer in a range of 0 to 20; and
n is an integer in a range of 0 to 20.

In some embodiments, the at least one functionalization ligand including an aminosilicone group is selected from the group consisting of

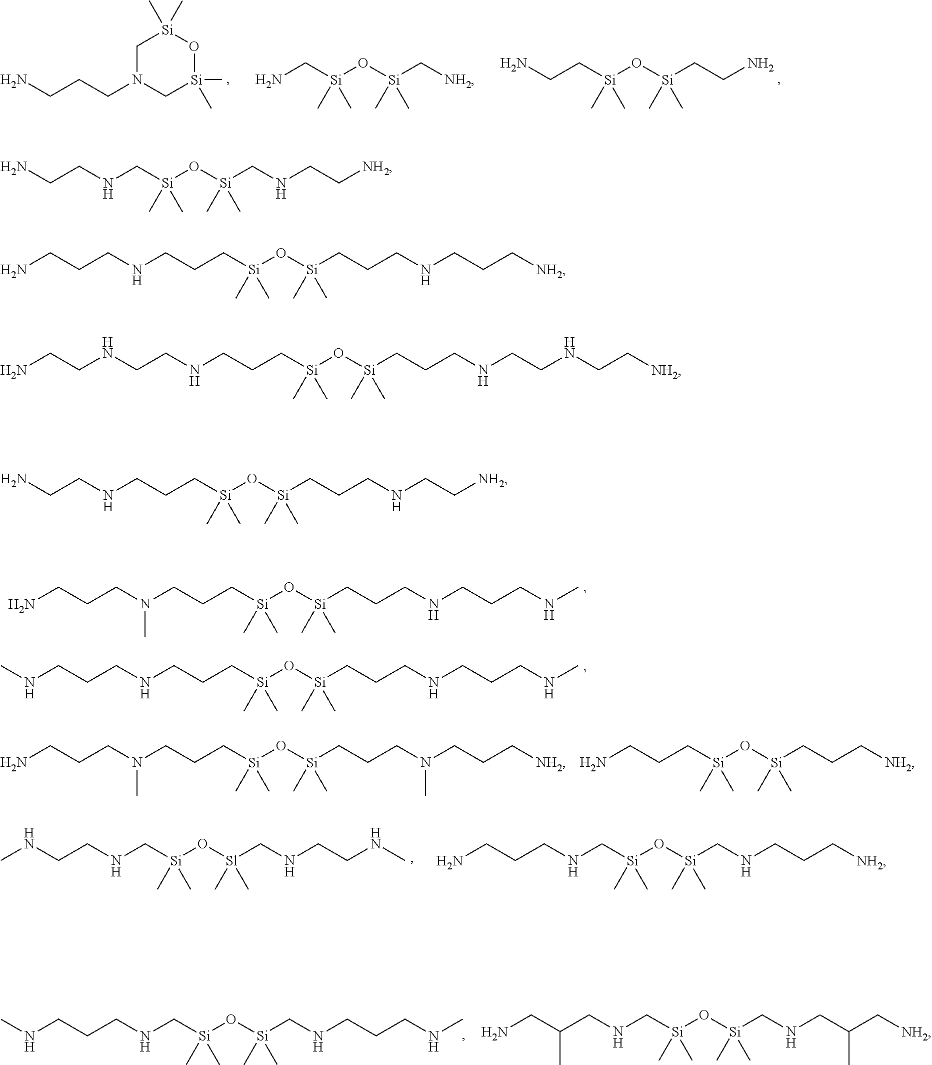

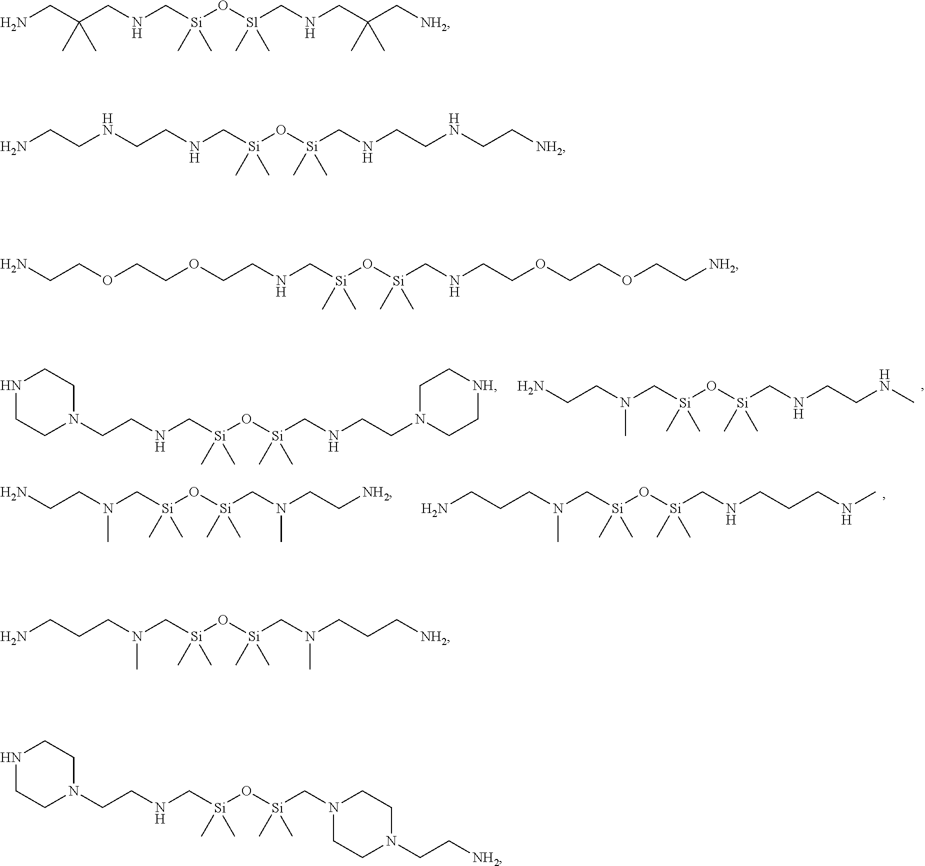

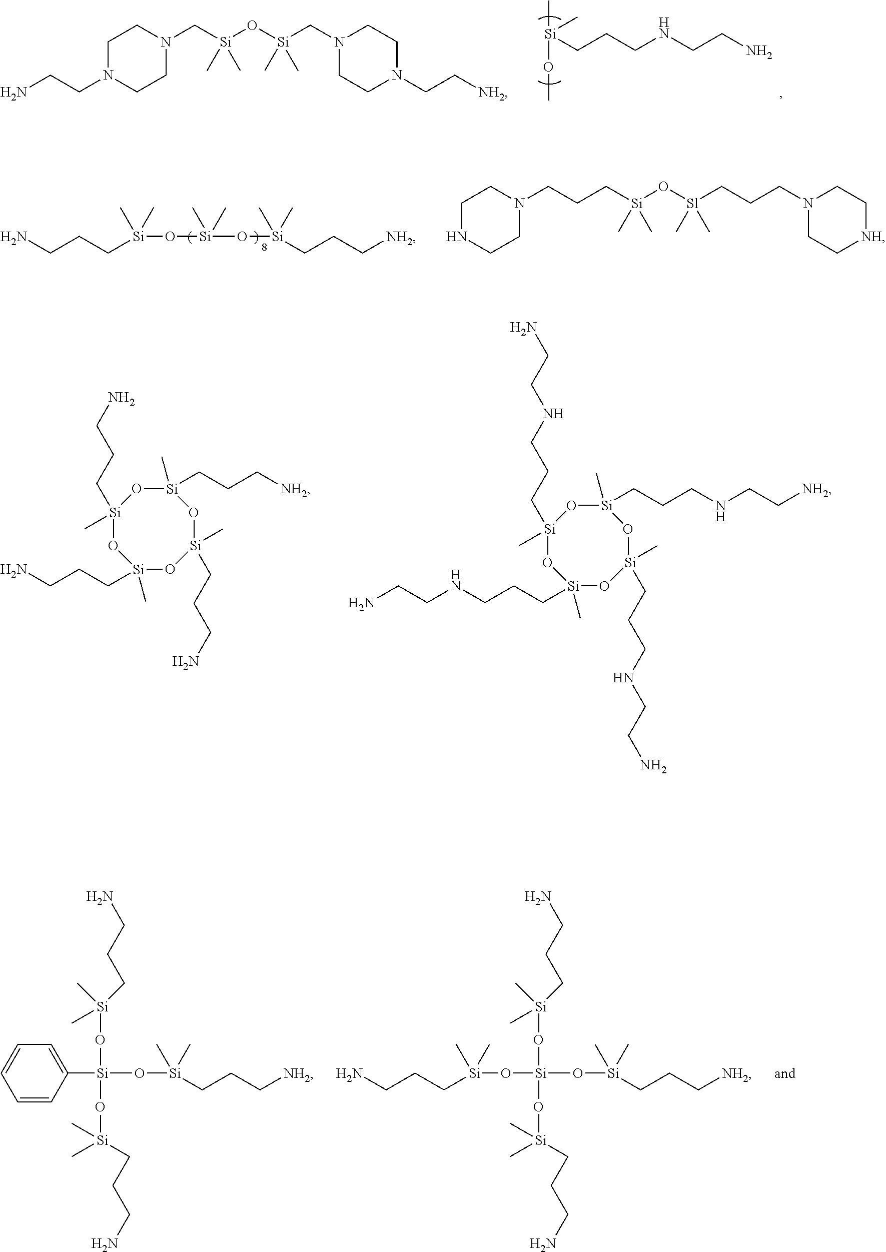

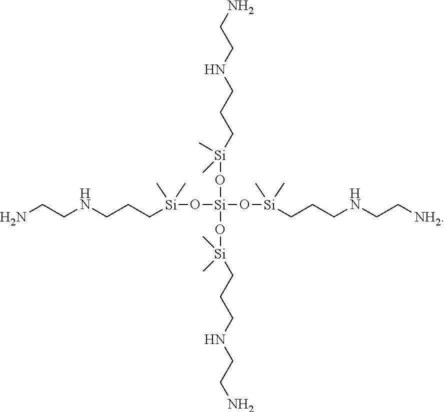 [SMILES: C[Si](C)(CCCNCCN)O[Si](O[Si](C)(C)CCCNCCN)(O[Si](C)(C)CCCNCCN)O[Si](C)(C)CCCNCCN]

Generally, the sorbent may be in any suitable form known in the art that facilitates the functionalized sorbent described herein. In some embodiments, the sorbent is in a form selected from the group consisting of powders, pellets, composites, composites mixed with binders, films, coatings, packed beds, columns, monoliths, and combinations thereof.

The exemplary embodiments described herein include a sorbent system. Generally, the sorbent system may be any suitable sorbent system known in the art that facilitates the functionalized sorbent described herein. In some embodiments, the sorbent system includes the functionalized sorbent and optionally a binder. In some embodiments, the sorbent system is disposed on a polymer film.

In some embodiments, the sorbent system includes at least one contactor. In some embodiments, the sorbent system includes more than one contactor. In some embodiments, the sorbent system includes a contactor configured for an adsorption cycle and a contactor configured for a desorption cycle. The contactor may be any suitable contactor known in the art that facilitates the functionalized sorbent described herein. In some embodiments, the sorbent is integrated into at least one channel of the contactor. In some embodiments, the contactor is fabricated from the sorbent itself. In some embodiments, the contactor is coated with the sorbent system. In some embodiments, the contactor includes more than one sorbent coating, with at least one sorbent coating being the sorbent system.

In some embodiments, the sorbent system includes a frame. The frame may be any suitable frame known in the art that facilitates the functionalized sorbent described herein. The frame may be included in the contactor or between two contactors. The frame may be composed of one piece or composed of more than one piece. In some embodiments, the frame is an air frame. In some embodiments, the frame is in a configuration selected from the group consisting of polygonal configurations, rectangular configurations, square configurations, circular configurations, asymmetrical configurations, and combinations thereof. In some embodiments, the sorbent system is mounted on the frame.

In some embodiments, the sorbent system includes at least one concentrator. The concentrator may be any suitable concentrator known in the art that facilitates the functionalized sorbent described herein. The concentrator may be a passive concentrator or an active concentrator.

In some embodiments, the sorbent system includes at least one component configured to drive fluid flow. The component configured to drive fluid flow may be any suitable component configured to drive fluid flow known in the art that facilitates the functionalized sorbent described herein. In some embodiments, the component configured to drive fluid flow is selected from the group consisting of pumps, fans, and combinations thereof.

In some embodiments, the sorbent system includes at least one component configured to alter temperature. The component configured to alter temperature may be any suitable component configured to alter temperature known in the art that facilitates the functionalized sorbent described herein. In some embodiments, the component configured to alter temperature is selected from the group consisting of heaters, coolers, and combinations thereof.

In some embodiments, the sorbent system includes at least one component configured to convey fluid. The component configured to convey fluid may be any suitable component configured to convey fluid known in the art that facilitates the functionalized sorbent described herein. In some embodiments, the component configured to convey fluid is selected from the group consisting of pipes, perforated pipes, plastic perforated pipes, polymeric perforated pipes, metal perforated pipes, composite perforated pipes, and combinations thereof.

Generally, the functionalized sorbent may be used according to any suitable purpose known in the art that facilitates the use of the functionalized sorbent described herein. In some embodiments, the functionalized sorbent is used in a sorbent system. In some embodiments, the functionalized sorbent is used in a carbon capture sorbent system. In some embodiments, the functionalized sorbent is used in a moisture sorbent system. In some embodiments, the functionalized sorbent is used in a carbon capture sorbent system in the presence of water. In some embodiments, the functionalized sorbent is used for capturing a gas. In some embodiments, the functionalized sorbent is used for post-combustion capturing of CO₂ and/or direct air capturing of CO₂.

The exemplary embodiments described herein include a method of making a sorbent system. Generally, the functionalized sorbent may be made according to any suitable synthesis method known in the art that facilitates the functionalized sorbent described herein.

In many embodiments, the method of making a sorbent system includes functionalizing a sorbent with at least one functionalization ligand including an aminosilicone group. In some embodiments, the method of making a sorbent system includes functionalizing the sorbent with at least two functionalization ligands each including an aminosilicone group, wherein the aminosilicone groups are different from each other. In some embodiments, the method of making a sorbent system further includes functionalizing the sorbent with at least one functionalization ligand not including an aminosilicone group. In some embodiments, the method of making a sorbent system includes controlling the ratio between the at least one functionalization ligand including an aminosilicone group and the at least one functionalization ligand not including an aminosilicone group.

In some embodiments, the method of making a sorbent system further includes annealing the functionalized sorbent. Annealing the sorbent system may remove excess ligands. In some embodiments, annealing the functionalized sorbent includes annealing the functionalized sorbent at an elevated temperature. In some embodiments, annealing the sorbent includes annealing the sorbent at a temperature in a range of from about 50° C. to about 400° C. In some embodiments, annealing the sorbent includes annealing the sorbent at a temperature in a range of from about 100° C. to about 300° C. In some embodiments, annealing the sorbent includes annealing the sorbent at a temperature in a range of from about 150° C. to about 250° C.

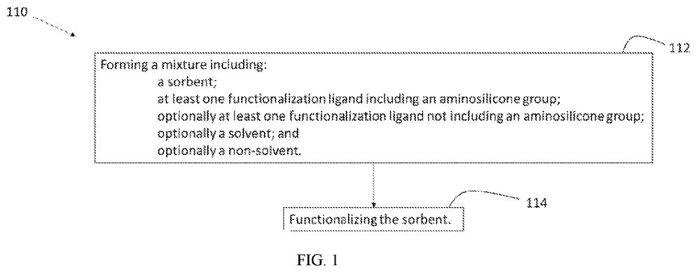

FIG. 1 is an exemplary method flow chart 110. In this exemplary embodiment, method flow chart 110 depicts exemplary steps of the method embodiments described herein and is not intended to limit the method embodiments. In the exemplary embodiment, the method includes forming 112 a mixture including: a sorbent; at least one functionalization ligand including an aminosilicone group; optionally at least one functionalization ligand not including an aminosilicone group; optionally a solvent, and optionally a non-solvent. The method also includes functionalizing 114 the sorbent.

In some embodiments, the method of making a functionalized sorbent includes (I) forming 112 a mixture including a sorbent, at least one functionalization ligand including an aminosilicone group, optionally at least one functionalization ligand not including an aminosilicone group, optionally a solvent, and optionally anon-solvent; and (II) functionalizing 114 the sorbent.

In some embodiments, functionalizing 114 the sorbent includes stirring the mixture.

In some embodiments, functionalizing 114 the sorbent includes functionalizing 114 the sorbent in the presence of an inert gas.

In some embodiments, functionalizing 114 the sorbent includes functionalizing 114 the sorbent at a temperature in a range of from about 0° C. to about 100° C. In some embodiments, functionalizing 114 the sorbent includes functionalizing 114 the sorbent at a temperature in a range of from about 20° C. to about 80° C. In some embodiments, functionalizing 114 the sorbent includes functionalizing 114 the sorbent at a temperature in a range of from about 20° C. to about 60° C.

In some embodiments, functionalizing 114 the sorbent includes functionalizing 114 the sorbent for a time in a range of from about one minute to about seven days. In some embodiments, functionalizing 114 the sorbent includes functionalizing 114 the sorbent for a time in a range of from about 1 hour to about three days.

In some embodiments, the sorbent is desolvated before functionalization 114. In some embodiments, the sorbent is dry before functionalization.

In some embodiments, the sorbent is annealed after functionalization 114. In some embodiments, annealing the sorbent includes annealing the sorbent at an elevated temperature. In some embodiments, annealing the sorbent includes annealing the sorbent at a temperature in a range of from about 50° C. to about 400° C. In some embodiments, annealing the sorbent includes annealing the sorbent at a temperature in a range of from about 100° C. to about 300° C. In some embodiments, annealing the sorbent includes annealing the sorbent at a temperature in a range of from about 150° C. to about 250° C.

In some embodiments, the sorbent is made according to the method disclosed in U.S. Provisional Patent Application No. 63/399,251. In some embodiments, the at least one functionalization ligand including an aminosilicone group is made according to the method disclosed in U.S. Provisional Patent Application No. 63/386,231.

In some embodiments, the solvent is an organic solvent. In some embodiments, the solvent is an aqueous solvent. In some embodiments, the solvent is a mixture of an organic solvent and an aqueous solvent.

Generally, a non-solvent is a substance incapable of dissolving a given component of a solution or mixture. In some embodiments, the non-solvent is a liquid-based component that is included in the reaction mixture. In some embodiments, the non-solvent is a solvent in which one of the components of the reaction mixture has limited solubility. In some embodiments, the non-solvent is selected from the group consisting of organic solvents, aqueous solvents, and combinations thereof.

In some embodiments, the non-solvent aids in functionalization. In some embodiments, the selectivity of the functionalization is controlled by relative solubility. For example, one or more of the sorbent or amines may possess a different solubility in the liquid-based reaction mixture compared to another sorbent or amine or the functionalized sorbent. In this way, relative solubility introduces limiting reactions and/or reagents.

In many embodiments, the method may also include any further suitable processing steps known in the art that facilitate the success of the method described herein. Such processing steps may include, but are not limited to only including, washing, drying, filtering, purifying, separating, centrifuging, and any combinations thereof. In some embodiments, the method further includes washing the functionalized sorbent. In some embodiments, the method further includes purifying the functionalized sorbent. In some embodiments, the purifying includes using distillation, vacuum distillation, and/or heat.

The exemplary embodiments described herein include a method of capturing at least one gas.

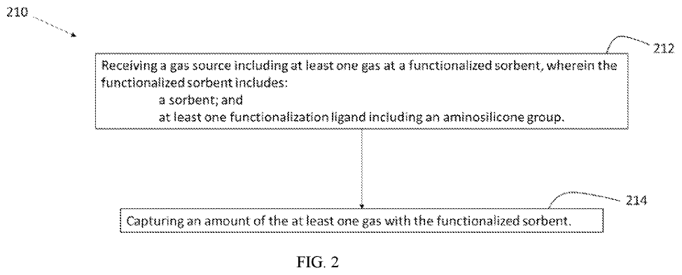

FIG. 2 is an exemplary method flow chart 210. In the exemplary embodiment, method flow chart 210 depicts exemplary method steps of the method embodiments described herein and is not intended to limit the method embodiments. The method includes receiving 212 a gas source including at least one gas at a functionalized sorbent, wherein the functionalized sorbent includes: a sorbent; and at least one functionalization ligand including an aminosilicone group. In some embodiments, the functionalized sorbent includes at least two functionalization ligands each including an aminosilicone group, wherein the aminosilicone groups are different from each other. In some embodiments, the functionalized sorbent further includes at least one functionalization ligand not including an aminosilicone group. The method also includes capturing 214 an amount of the at least one gas with the functionalized sorbent.

In some embodiments, the method includes: (I) receiving 212 a gas source including the at least one gas at a functionalized sorbent, wherein the functionalized sorbent includes a sorbent and at least one functionalization ligand including an aminosilicone group; and (II) capturing 214 an amount of the at least one gas with the functionalized sorbent.

Generally, the gas source may be any suitable gas source known in the art that facilitates the method described herein. In some embodiments, the gas source is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

Generally, the at least one gas may be any suitable gas known in the art that facilitates the method described herein. In some embodiments, the at least one gas is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

In some embodiments, the at least one gas is present in the source gas in an amount in a range of from about 0.001% (v/v) to about 10% (v/v). In some embodiments, the at least one gas is present in the source gas in an amount in a range of from about 0.001% (v/v) to about 5% (v/v). In some embodiments, the at least one gas is present in the source gas in an amount in a range of from about 0.001% (v/v) to about 1% (v/v). In some embodiments, the at least one gas is present in the source gas in an amount greater than 10% (v/v).

In some embodiments, the at least one gas is present in the source gas in an amount in a range of from about 100 ppmv to about 1000 ppmv. In some embodiments, the at least one gas is present in the source gas in an amount in a range of from about 300 ppmv to about 5000 ppmv.

In some embodiments, the at least one gas includes water vapor. In some embodiments, the at least one gas includes water vapor in an amount in a range of from about 0.001% (v/v) to about 25% (v/v). In some embodiments, the at least one gas includes water vapor in an amount in a range of from about 0.01% (v/v) to about 20% (v/v). In some embodiments, the at least one gas includes water vapor in an amount in a range of from about 0.5% (v/v) to about 15% (v/v). In some embodiments, the at least one gas includes water vapor in an amount in a range of from about 0.5% (v/v) to about 4% (v/v). In some embodiments, the at least one gas includes water vapor in an amount in a range of from about 4% (v/v) to about 15% (v/v).

In some embodiments, the at least one gas is present in the source gas in an amount in a range of from about 0.001% (v/v) to about 10% (v/v) and is in the presence of water vapor. In some embodiments, the at least one gas is present in the source gas in an amount in a range of from about 0.001% (v/v) to about 5% (v/v) and is in the presence of water vapor. In some embodiments, the at least one gas is present in the source gas in an amount in a range of from about 0.001% (v/v) to about 1% (v/v) and is in the presence of water vapor. In some embodiments, the at least one gas is present in the source gas in an amount greater than about 10% (v/v) and is in the presence of water vapor. In some embodiments, the water vapor is present in an amount in a range of from about 0.001% (v/v) to about 25% (v/v). In some embodiments, the water vapor is present in an amount in a range of from about 0.01% (v/v) to about 20% (v/v). In some embodiments, the water vapor is present in an amount in a range of from about 0.5% (v/v) to about 10% (v/v).

In some embodiments, capturing 214 an amount of the at least one gas with the functionalized sorbent includes adsorbing an amount of the at least one gas with the functionalized sorbent. In some embodiments, capturing 214 an amount of the at least one gas with the functionalized sorbent includes adsorbing an amount of the at least one gas with the functionalized sorbent in the presence of water vapor.

In some embodiments, the amount of the at least one gas captured 214 with the functionalized sorbent is in a range of from about 1% (v/v) to about 100% (v/v) of the at least one gas present in the source gas. In some embodiments, the amount of the at least one gas captured 214 with the functionalized sorbent is in a range of from about 10% (v/v) to about 90% (v/v) of the at least one gas present in the source gas. In some embodiments, the amount of the at least one gas captured 214 with the functionalized sorbent is in a range of from about 20% (v/v) to about 80% (v/v) of the at least one gas present in the source gas. In some embodiments, the amount of the at least one gas captured 214 with the functionalized sorbent is in a range of from about 30% (v/v) to about 70% (v/v) of the at least one gas present in the source gas. In some embodiments, the amount of the at least one gas captured 214 with the functionalized sorbent is in a range of from about 40% (v/v) to about 60% (v/v) of the at least one gas present in the source gas.

In some embodiments, the amount of the at least one gas captured 214 with the functionalized sorbent is in a range of from about 1% (v/v) to about 25% (v/v) of the at least one gas present in the source gas. In some embodiments, the amount of the at least one gas captured 214 with the functionalized sorbent is in a range of from about 1% (v/v) to about 20% (v/v) of the at least one gas present in the source gas. In some embodiments, the amount of the at least one gas captured 214 with the functionalized sorbent is in a range of from about 1% (v/v) to about 15% (v/v) of the at least one gas present in the source gas. In some embodiments, the amount of the at least one gas captured 214 with the functionalized sorbent is in a range of from about 1% (v/v) to about 10% (v/v) of the at least one gas present in the source gas. In some embodiments, the amount of the at least one gas captured 214 with the functionalized sorbent is in a range of from about 1% (v/v) to about 5% (v/v) of the at least one gas present in the source gas.

In some embodiments, the amount of the at least one gas captured 214 with the functionalized sorbent is in a range of from about 80% (v/v) to about 100% (v/v) of the at least one gas present in the source gas. In some embodiments, the amount of the at least one gas captured 214 with the functionalized sorbent is in a range of from about 85% (v/v) to about 100% (v/v) of the at least one gas present in the source gas. In some embodiments, the amount of the at least one gas captured 214 with the functionalized sorbent is in a range of from about 90% (v/v) to about 100% (v/v) of the at least one gas present in the source gas. In some embodiments, the amount of the at least one gas captured 214 with the functionalized sorbent is in a range of from about 95% (v/v) to about 100% (v/v) of the at least one gas present in the source gas.

In some embodiments, the source gas is modified to alter the amount of water vapor. In some embodiments, altering the amount of water vapor includes increasing the amount of water vapor. In some embodiments, altering the amount of water vapor includes decreasing the amount of water vapor. In some embodiments, increasing the amount of water vapor includes adding or injecting water vapor into the source gas. In some embodiments, decreasing the amount of water vapor includes removing water vapor from the source gas by evaporation, condensation, and/or pre-adsorption. In some embodiments, altering the amount of water vapor includes exhaust gas recirculation (EGR) and/or mixing.

In many embodiments, the functionalized sorbent, the source gas, the at least one gas, or a combination thereof are at a certain temperature. Each temperature may be altered to facilitate the method described herein. Each temperature may have a uniform temperature profile, a gradient temperature profile, a discrete temperature profile, or a combination thereof.

In some embodiments, the method includes an adsorption cycle. In some embodiments, the method includes a desorption cycle. In some embodiments, at least one of the functionalized sorbent, the source gas, the at least one gas, or a combination thereof are at a temperature in a range of from about 0° C. to about 150° C. during the gas adsorption cycle. In some embodiments, at least one of the functionalized sorbent, the source gas, the at least one gas, or a combination thereof are at a temperature in a range of from about 60° C. to about 250° C. during the gas desorption cycle.

In some embodiments, the method includes controlling a temperature. Temperature may be controlled for the functionalized sorbent, the source gas, the at least one gas, or a combination thereof.

The exemplary embodiments described herein include a method of collecting at least one gas from a gas source.

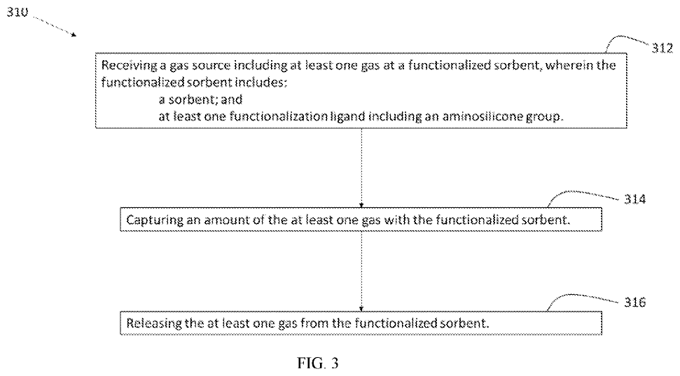

FIG. 3 is an exemplary method flow chart 310. In this exemplary embodiment, method flow chart 310 depicts exemplary method steps of the method embodiments described herein and is not intended to limit the method embodiments. The method includes receiving 312 a gas source including at least one gas at a functionalized sorbent, wherein the functionalized sorbent includes: a sorbent; and at least one functionalization ligand including an aminosilicone group. In some embodiments, the functionalized sorbent includes at least two functionalization ligands each including an aminosilicone group, wherein the aminosilicone groups are different from each other. In some embodiments, the functionalized sorbent further includes at least one functionalization ligand not including an aminosilicone group. The method also includes capturing 314 an amount of the at least one gas with the functionalized sorbent. The method also includes releasing 316 the at least one gas from the functionalized sorbent.

In some embodiments, the method includes: (I) receiving 312 a gas source including at least one gas at a functionalized sorbent, wherein the functionalized sorbent includes a sorbent and at least one functionalization ligand including an aminosilicone group; (It) capturing 314 an amount of the at least one gas with the functionalized sorbent; and (III) releasing 316 the at least one gas from the functionalized sorbent.

In some embodiments, releasing 316 the at least one gas from the functionalized sorbent includes purging the at least one gas from the functionalized sorbent with a purge gas. In some embodiments, releasing 316 the at least one gas from the functionalized sorbent includes receiving a change in temperature or pressure at the functionalized sorbent.

In some embodiments, the at least one gas is released 316 from the functionalized sorbent into a receiving gas. In some embodiments, the receiving gas is selected from the group consisting of air, N₂, steam, and combinations thereof. In some embodiments, the receiving gas is removed from the presence of the functionalized sorbent after receiving the at least one gas. In some embodiments, the receiving gas has a higher concentration of the at least one gas compared to the source gas.

Further aspects of the present disclosure are provided by the subject matter of the following clauses:

1. A functionalized sorbent comprising:
a sorbent; and
at least one functionalization ligand comprising an aminosilicone group.

2. A method of making a functionalized sorbent, the method comprising:
(I) forming a mixture comprising:
   a sorbent;
   at least one functionalization ligand including an aminosilicone group;
   optionally at least one functionalization ligand not including an aminosilicone group;
   optionally a solvent; and
   optionally a non-solvent; and
(II) functionalizing the sorbent.

3. A method of capturing at least one gas, the method comprising:
(I) receiving a gas source comprising the at least one gas at a functionalized sorbent, wherein the functionalized sorbent comprises:
   a sorbent; and
   at least one functionalization ligand comprising an aminosilicone group; and
(II) capturing an amount of the at least one gas with the functionalized sorbent.

4. A method of collecting at least one gas, the method comprising:
(I) receiving a gas source comprising the at least one gas at a functionalized sorbent, wherein the functionalized sorbent comprises:
   a sorbent; and
   at least one functionalization ligand comprising an aminosilicone group;
(II) capturing an amount of the at least one gas with the functionalized sorbent; and
(III) releasing the at least one gas from the functionalized sorbent.

5. The functionalized sorbent in accordance with any preceding clause, further comprising at least one functionalization ligand that does not comprise an aminosilicone group.

6. The functionalized sorbent in accordance with any preceding clause, wherein the at least one functionalization ligand comprising an aminosilicone group and the at least one functionalization ligand not comprising an aminosilicone group are present in a ratio in a range of from about 10:1 to about 1:10.

7. The functionalized sorbent in accordance with any preceding clause, wherein the sorbent is selected from the group consisting of coordination framework compounds, metal-organic framework (MOF) compounds, porous coordination polymers (PCPs), covalent organic framework (COF) compounds, zeolitic imidazolate framework (ZIF) compounds, crystalline porous materials, crystalline open frameworks, reticular chemistry, silica particles, zeolites, silico-alumino-phosphates (SAPOs), alumino-phosphates (AlPOs), polyaromatic frameworks (PAFs), activated carbons, molecular organic solids, and combinations thereof.

8. The functionalized sorbent in accordance with any preceding clause, wherein the functionalized sorbent is a functionalized MOF compound of Formula (I)

$${M}_{x} {L}_{y} {F}_{a}^{A} {F}_{b}^{B} , \qquad ( Formula I )$$

wherein:
M is a MOF metal or metal-containing cluster;
L is a MOF linker;
F^{A} is the at least one functionalization ligand comprising an aminosilicone group;
F^{B} is at least one functionalization ligand not comprising an aminosilicone group;
x is a value in a range of 1 to 6:
y is a value in a range of 1 to 6;
a is a value greater than 0 and less than or equal to 2; and
b is a value in a range of 0 to 2.

9. The functionalized sorbent in accordance with any preceding clause, wherein the MOF metal or metal-containing cluster comprises a metal selected from the group consisting of alkali metals, alkaline earth metals, transition metals, Mg, Ca, Mn, Cr, Fe, Co, Ni, Cu, Zn, ions thereof, hydrates thereof, salts thereof, halides thereof, fluorides thereof, chlorides thereof, bromides thereof, iodides thereof, nitrates thereof, acetates thereof, sulfates thereof, phosphates thereof, carbonates thereof, oxides thereof, formates thereof, carboxylates thereof, and combinations thereof.

10. The functionalized sorbent in accordance with any preceding clause, wherein the MOF linker comprises a linker selected from the group consisting of polytopic linkers, 4,4′-dihydroxy-[1,1′-biphenyl]-3,3′-dicarboxylic acid (H₄dobpdc), 4,4′-dioxidobiphenyl-3,3′-dicarboxylate (dobpdc⁴⁻), 4,4″-dioxido-[1,1′:4′,1″-terphenyl]-3,3″-dicarboxylate (dotpdc⁴⁻), 2,5-dioxidobenzene-1,4-dicarboxylate (dobdc⁴⁻), 4,6-Dihydroxyisophthalic acid (m-dobdc⁴⁻), 3,3′-dioxido-biphenyl-4,4′-dicarboxylate (para-carboxylate-dobpdc⁴⁻), 4,4′-[oxalylbis(imino)]bis(2-hydroxybenzoic acid) (H₄ODA), 4,4′-[1,4-phenylenebis-(carbonylimino)]bis(2-hydroxybenzoic acid) (H₄TDA), 4,4′-Dihydroxyazobenzene-3,3′-dicarboxylic acid (H₄OSA), dicarboxylates, terephthalic acid, tricarboxylates, 1,3,5-benzentricarboxylic acid, azolates, tetrazolates, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octanedicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis-(phenylamino)benzene-2,5-dicarboxylic acid, 1,1′-dinaphthyl-8,8′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro) phenylpyrazoline-4,5-dicarboxylic acid, 1,4,5,6,7,7,-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cisdicarboxylic acid, 2,2′-biquinoline-4,4′-dicarboxylic acid, pyridine-3,4-dicarboxylic acid, 3,6,9-trioxaundecanedicarboxylic acid, o-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyletherdiimidedicarboxylic acid, 4,4′-diaminodiphenylmethanediimidedicarboxylic acid, 4,4′-diaminodiphenylsulfonediimidedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′-3′-diphenyl-p-terphenyl-4,4″-dicarboxylic acid, diphenylether-4,4′-dicarboxylic acid, imidazole-4,5-dicarboxylic acid, 4(1H)-oxothiochromene-2,8-dicarboxylic acid, 5-t-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptanedicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-TH-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, aurinetricarboxylic acid, 1,1-dioxide-perylo[1,12-BCD]thiophene-3,4,9,10-tetracarboxylic acid, perylenetetracarboxylic acids, perylene-3,4,9,10-tetracarboxylic acid, perylene-1,12-sulfone-3,4,9,10-tetracarboxylic acid, butanetetracarboxylic acids, 1,2,3,4-butanetetracarboxylic acid, meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, cyclopentanetetracarboxylic acids, cyclopentane-1,2,3,4-tetracarboxylic acid, polytopic linkers, ditopic linkers, tritopic linkers, tetratopic linkers, pentatopic linkers, hexatopic linkers, heptatopic linkers, octatopic linkers, mixed linkers, desymmetrized linker, metallo linkers, N-heterocyclic linkers, protonated, partially and fully deprotonated forms thereof, and combinations thereof.

11. The functionalized sorbent in accordance with any preceding clause, wherein the at least one functionalization ligand comprising an aminosilicone group comprises at least one amine selected from the group consisting of primary amines, secondary amines, tertiary amines, and combinations thereof.

12. The functionalized sorbent in accordance with any preceding clause, wherein the at least one functionalization ligand comprising an aminosilicone group comprises at least one amine selected from the group consisting of monoamines, diamines, triamines, tetra-amines, penta-amines, hexa-amines, polyamines, and combinations thereof.

13. The functionalized sorbent in accordance with any preceding clause, wherein the at least one functionalization ligand comprising an aminosilicone group comprises at least one aminosilicone selected from the group consisting of linear aminosilicones, cyclic aminosilicones, branched aminosilicones, amino-substituted siloxanes, linear amino-substituted disiloxanes, cyclic amino-substituted disiloxanes, linear amino-substituted trisiloxanes, cyclic amino-substituted trisiloxanes, linear amino-substituted tetrasiloxanes, cyclic amino-substituted tetrasiloxanes, linear amino-substituted polysiloxanes, cyclic amino-substituted polysiloxanes, silsesquioxanes, polyoctahedral silsesquioxanes, and combinations thereof.

14. The functionalized sorbent in accordance with any preceding clause, wherein the at least one functionalization ligand comprising an aminosilicone group comprises a symmetrical structure.

15. The functionalized sorbent in accordance with any preceding clause, wherein the at least one functionalization ligand comprising an aminosilicone group comprises an asymmetrical structure.

16. The functionalized sorbent in accordance with any preceding clause, wherein the at least one functionalization ligand comprising an aminosilicone group is an amino-substituted siloxane of Formula (II), Formula (III), Formula (IV), Formula (V), Formula (VI), or Formula (VII)

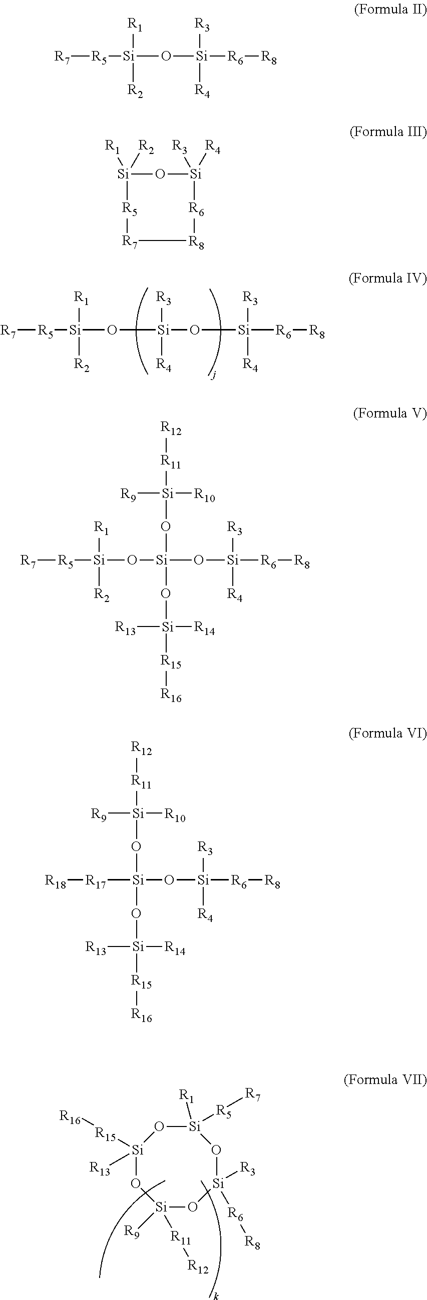

wherein:
R₁, R₂, R₃, R₄, R₉, R₁₀, R₁₃, R₁₄, and R₁₈ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₅, R₆, R₁₁, R₁₅, and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl,
R₇, R₈, R₁₂, and R₁₆ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, and substituents of Formula (VIII)

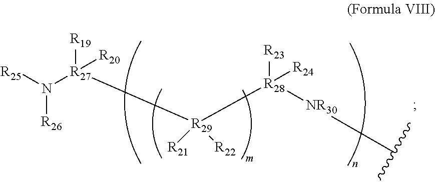

wherein:
the wavy bond indicates a bonding location to Formula (II) or Formula (III) or Formula (IV) or Formula (V) or Formula (VI) or Formula (VII);
R₁₉, R₂₀, R₂₁, R₂₂, R₂₃, and R₂₄ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₂₅ and R₂₆ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₂₅ and R₂₆ form a single ring selected from the group consisting of heterocycloalkyl and heteroaryl;
R₂₇, R₂₈, and R₂₉ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₀ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl;
j is an integer in a range of 0 to 20;
k is an integer in a range of 0 to 20;
m is an integer in a range of 0 to 20; and
n is an integer in a range of 0 to 20.

17. The functionalized sorbent in accordance with any preceding clause, wherein the at least one functionalization ligand comprising an aminosilicone group is selected from the group consisting of

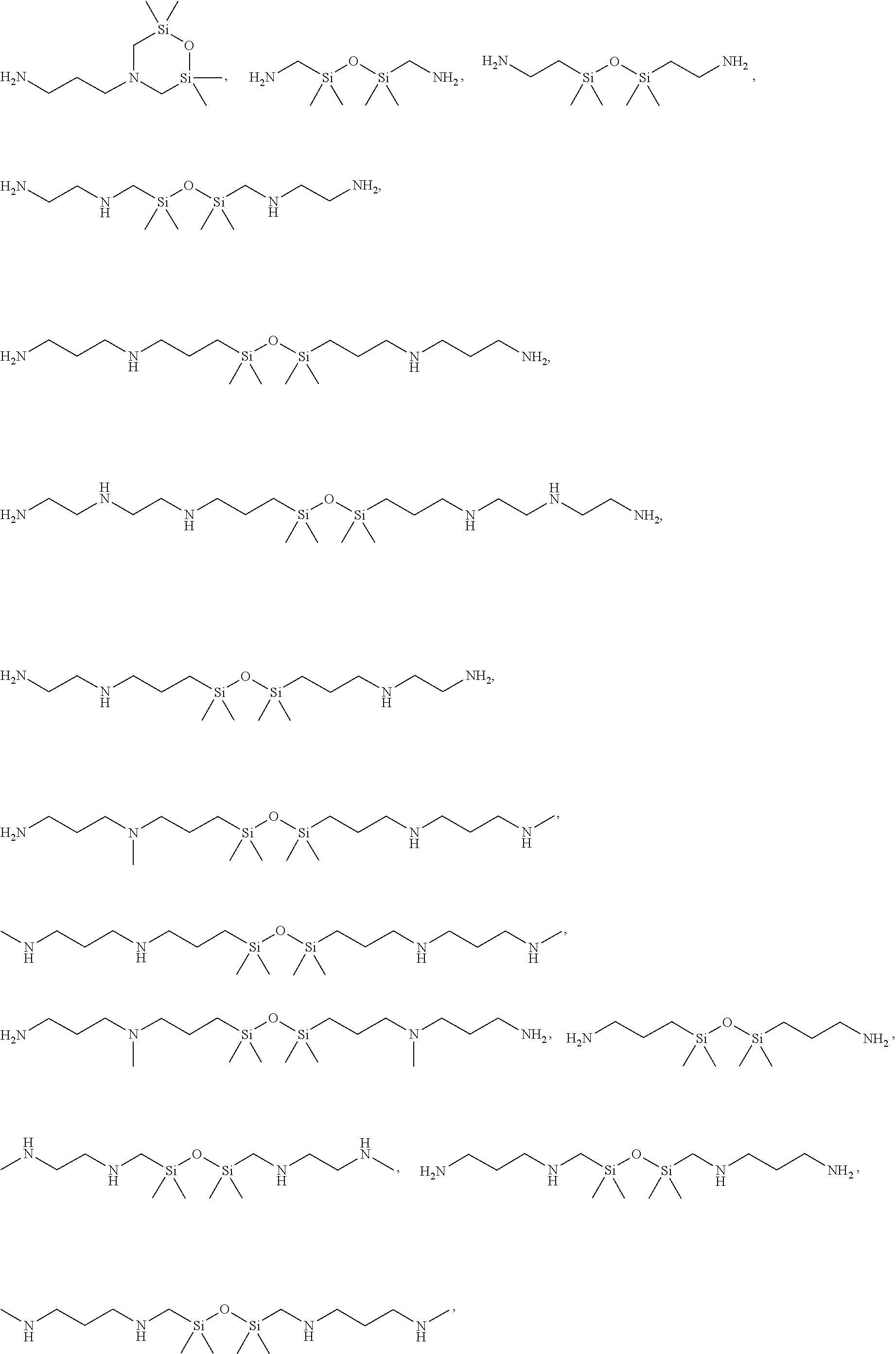

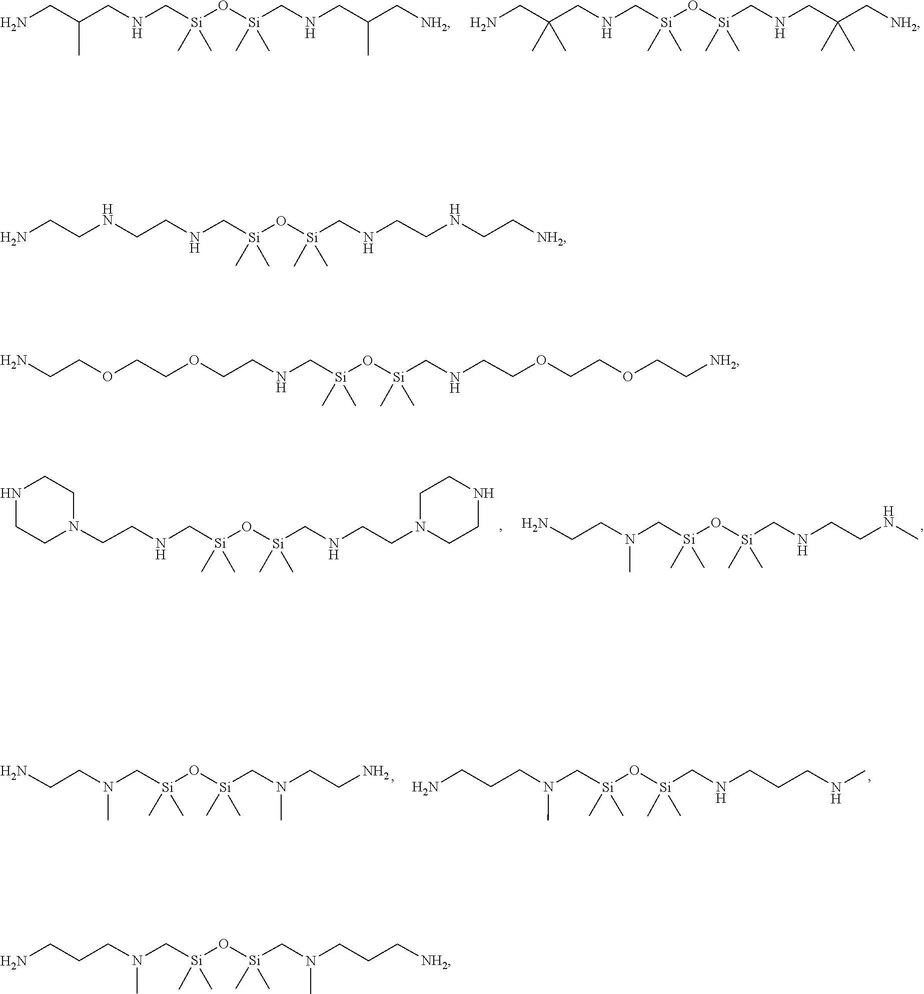

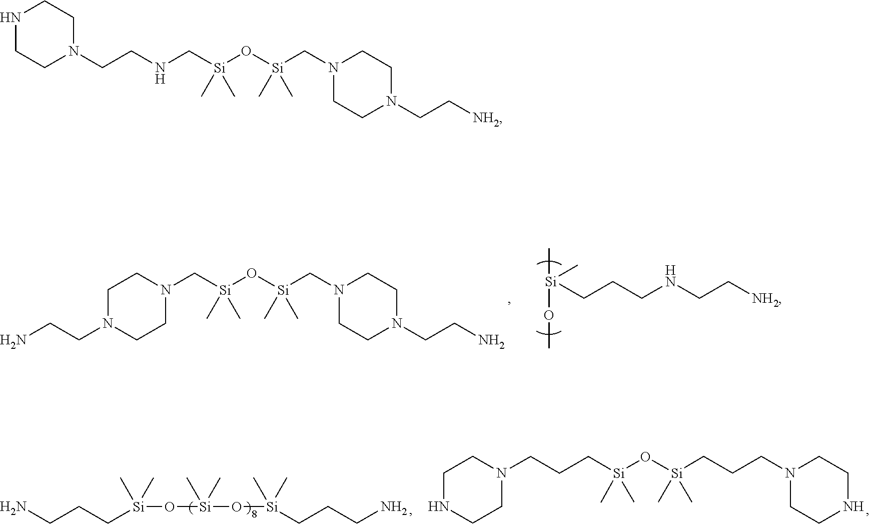

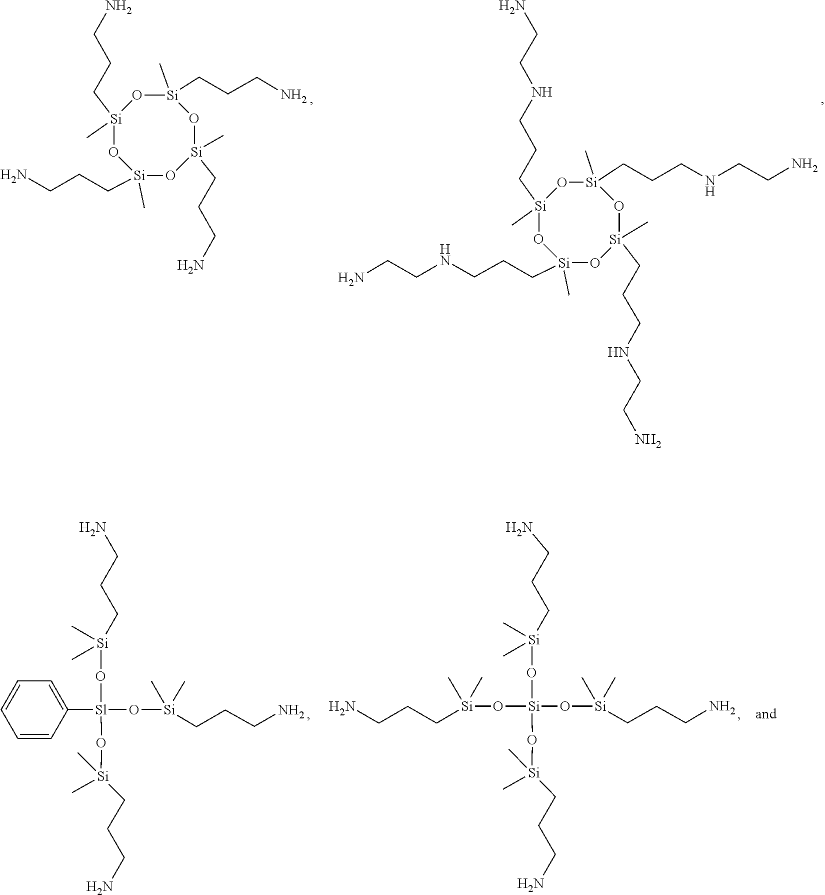

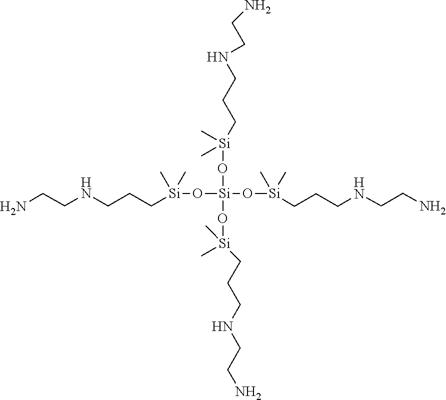 [SMILES: C[Si](C)(CCCNCCN)O[Si](O[Si](C)(C)CCCNCCN)(O[Si](C)(C)CCCNCCN)O[Si](C)(C)CCCNCCN]

18. A sorbent system comprising the functionalized sorbent in accordance with any preceding clause.

19. The method in accordance with any preceding clause, wherein functionalizing the sorbent comprises stirring the mixture.

20. The method in accordance with any preceding clause, wherein functionalizing the sorbent comprises functionalizing the sorbent in the presence of an inert gas.

21. The method in accordance with any preceding clause, wherein functionalizing the sorbent comprises functionalizing the sorbent at a temperature in a range of from about 0° C. to about 100° C.

22. The method in accordance with any preceding clause, wherein functionalizing the sorbent comprises functionalizing the sorbent for a time in a range of from about 1 minute to about seven days.

23. The method in accordance with any preceding clause, wherein the sorbent is desolvated before functionalization.

24. The method in accordance with any preceding clause, wherein the sorbent is dry before functionalization.

25. The method in accordance with any preceding clause, wherein the sorbent is annealed at an elevated temperature after functionalization.

26. The method in accordance with any preceding clause, wherein the solvent is selected from the group consisting of organic solvents, aqueous solvents, and combinations thereof.

27. The method in accordance with any preceding clause, wherein the gas source is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

28. The method in accordance with any preceding clause, wherein the at least one gas is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

29. A method of collecting at least one gas from a gas source, the method comprising:
capturing the at least one gas according to the method in accordance with any preceding clause, and
(III) releasing the at least one gas from the functionalized sorbent.

30. The method in accordance with any preceding clause, wherein the at least one gas is in the presence of water.

31. The method in accordance with any preceding clause, further comprising capturing an amount of water with the functionalized sorbent.

32. The method in accordance with any preceding clause, further comprising releasing water from the functionalized sorbent.

References to “some embodiments” in the above description are not intended to be interpreted as excluding the existence of additional embodiments that also incorporate the recited features.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Synthesis of MOF Compound 1

A 20 milliliter scintillation vial was charged with 2 eq. of 1,3-bis(aminoethylaminomethyl)tetramethyldisiloxane (AEAM, 0.556 g, 2 mmol, 2 eq.) and dissolved in 5 mL toluene. Then, 0.320 g (1 mmol) of Mg₂(dobpdc) that was desolvated in a 120° C. vacuum oven overnight was added to the vial. The slurry was then stirred at 60° C. on a hot plate for 3 days at 300-400 rpm. The material was cooled to room temperature and transferred to a conical tube. The material was spun down at a rate of 4000 rpm for 2 minutes, then the solvent was decanted and resuspended in another 10 mL of toluene for 4-6 hours. It was centrifuged, decanted, and dried in a 120° C. vacuum oven overnight to obtain 0.4881 g of MOF Compound 1 (84% yield, Mg₂(dobpdc)(AEAM)₀₋₉₄).

¹H NMR analysis was performed on the final material after digestion with 20 μL of 35% DCl in D₂O, 200 μL of D₂O, and 600 μL of DMSO-d6. ¹H NMR (DMSO-d₆, D₂O) δ 7.87 (dd, 2H), 7.70 (dd, 2H), 7.00 (dd, 2H), 3.22-3.16 (m, 7.52H), 2.38 (s, 3.76H), 0.17 (s, 11.28H).

### Example 2. Synthesis of MOF Compound 2

A 250 mL, 3-neck round-bottom flask was charged with spermine (1.406 g, 0.0069 mol, 1.2 eq.), and dissolved in 60 mL toluene which was sparged with N₂ via a gas dispersion tube for 30 minutes. Then, 1.846 g (0.0058 mol, 1 eq.) of Mg₂(dobpdc) that was desolvated in a 120° C. vacuum oven overnight was added to the vessel. The slurry was stirred at 60° C. under N₂ for 3 days at 300 rpm. The material was cooled to room temperature and collected via vacuum filtration. The filter cake was taken up in another 100 mL of toluene, stirred at room temperature for 2 hours and filtered. The material was placed in a glass container and dried in a 120° C. vacuum oven overnight to obtain 2.738 g of MOF Compound 2 (90.3% yield, Mg₂(dobpdc)(spermine)_{1.01}).

¹H NMR analysis was performed on the final material after digestion with 20 μL of 35% DCl in D₂O, 200 μL of D₂O, and 600 μL of DMSO-d6. ¹H NMR (DMSO-d₆, D₂O) δ 7.86 (dd, 2H), 7.69 (dd, 2H), 6.99 (dd, 2H), 2.98-2.88 (m, 12H), 1.93 (m, 4H), 1.65 (bs, 4H)

### Example 3. Synthesis of MOF Compound 3

A 1-liter (L), 3-neck round-bottom flask was charged with spermine (13.25 g, 0.065 mol, 3 eq.), and dissolved in 220 mL toluene which was sparged with N₂ via a gas dispersion tube for 30 minutes. Then, (7.0 g, 0.022 mol, 1 eq.) of Mg₂(dobpdc) that was desolvated in a 120° C. vacuum oven overnight was added to the vessel. The slurry was then sparged with N₂ for another 30 minutes and stirred at 60° C. under N₂ for 3 days at 300-400 rpm. The material was cooled to room temperature and collected via vacuum filtration. The filter cake was taken up in another 300 mL of toluene, stirred at room temperature for 4-6 hours and filtered. This step was repeated once more. The material was placed in a glass container and dried in a 120° C. vacuum oven overnight to obtain 8.25 g of MOF Compound 3 (67.1% yield, Mg₂(dobpdc)(spermine)_{1.2}).

¹H NMR analysis was performed on the final material after digestion with 20 μL of 35% DCl in D₂O, 200 μL of D₂O, and 600 μL of DMSO-d6. ¹H NMR (DMSO-d₆, D₂O) δ 7.85 (dd, 2H), 7.66 (dd, 2H), 6.98 (dd, 2H), 2.98-2.86 (m, 14.4H), 1.93 (m, 4.8H), 1.65 (bs, 4.8H).

### Example 4. Synthesis of MOF Compound 4

A 20 mL scintillation vial was charged with 1 eq. of spermidine (0.0526 g, 0.36 mmol) and dissolved in 5 mL toluene. Then, 0.160 g (0.36 mmol) of Mg₂(dobpdc)(IPA)₂ that was desolvated in a 120° C. vacuum oven overnight was added to the vial. The slurry was then stirred at 60° C. on a hot plate for overnight at 300-400 rpm. The material was cooled to room temperature and transferred to a conical tube. The material was spun down at a rate of 4000 rpm for 2 minutes, the solvent was decanted and then resuspended in another 10 mL of toluene for 4-6 hours. It was centrifuged, decanted and dried in a 120° C. vacuum oven overnight to obtain 0.139 g of MOF Compound 4 (80.1% yield, Mg₂(dobpdc)(spermidine)_{1.08}).

¹H NMR analysis was performed on the final material after digestion with 20 μL of 35% DCl in D₂O, 200 μL of D₂O, and 600 μL of DMSO-d6. ¹H NMR (DMSO-d₆, D₂O) δ 7.85 (dd, 2H), 7.68 (dd, 2H), 6.98 (dd, 2H), 2.97-2.78 (m, 8.64H), 1.92 (m, 2.16H), 1.61 (m, 4.32H).

### Example 5. Method of Varying the Amounts of Functionalization Ligands Including an Aminosilicone Group and Functionalization Ligands not Including an Aminosilicone Group

The metal-organic framework (MOF) is synthesized via an aqueous preparation method and washed thrice with water and thrice with a solvent (e.g., isopropyl alcohol). Then, the material is dried via vacuum filtration to obtain a material that is about 70-75% solvated. An accurate molar amount of MOF can be determined by determining how much leftover solvent is present in the MOF. One possible method for this determination is analysis of a solvent peak via ¹H NMR e.g. Mg₂(dobpdc)₁(alcohol)ₓ.

¹H NMR analysis was performed on Mg₂(dobpdc)₁(TPA)_{1.92} after digestion with 20 μL of 35% DCl in D₂O, 200 μL of D₂O, and 600 μL of DMSO-d6. ¹H NMR (DMSO-d₆, D₂O) δ 7.86 (dd, 2H), 7.69 (dd, 2H), 6.99 (dd, 2H), 3.75 (m, 1H), 1.00 (d, 6H).

By adding at least one functionalization ligand not including an aminosilicone group, such as spermine, as the limiting reagent in x equivalents, and at least one functionalization ligand including an aminosilicone group, such as AEAM, as the excess reagent, a material can be formed with the composition of (MOF Metal)ₓ(MOF Linker)_{y} (at least one functionalization ligand not including an aminosilicone group)_{z} (at least one functionalization ligand including an aminosilicone group)_{1-z}.

### Example 6. Synthesis of MOF Compound 5

A 1-L, 3-neck round-bottom flask was charged with spermine (3.14 g, 0.016 mol, 0.5 eq.), 1,3-bis(aminoethylaminomethyl)tetramethyldisiloxane (AEAM, 6.48 g, 0.023 mol, 0.75 eq.) and 310 mL toluene, and was sparged with N₂ via a gas dispersion tube for 30 minutes. Then, 10 g (0.031 mol, 1 eq.) of Mg₂(dobpdc) that was desolvated in a 120° C. vacuum oven overnight was added to the vessel. The slurry was then sparged with N₂ for another 30 minutes and stirred at 60° C. under N₂ for 3 days at 300-400 rpm. The material was cooled to room temperature and collected via vacuum filtration. The filter cake was taken up in another 300 mL of toluene, stirred at room temperature for 4-6 hours and filtered. The material was placed in a glass container and dried in a 120° C. vacuum oven overnight to obtain 12.8 g of MOF Compound 5 (75% yield, Mg₂(dobpdc)(spermine)_{0.65}(AEAM)_{0.35}).

¹H NMR analysis was performed on the final material after digestion with 20 μL of 35% DCl in D₂O, 200 μL of D₂O, and 600 μL of DMSO-d6. ¹H NMR (DMSO-d₆, D₂O) δ 7.85 (dd, 2H), 7.68 (dd, 2H), 7.01 (dd, 2H), 3.22-3.16 (m, 2.8H), 2.98-2.86 (m, 7.8H), 2.38 (s, 1.4H), 1.93 (m, 2.6H), 1.65 (bs, 2.6H), 0.16 (s, 4.2H).

### Example 7. Synthesis of MOF Compound 6

A 20 mL scintillation vial was charged with spermidine (0.0363 g, 0.25 mmol, 0.5 eq.), 1,3-bis(aminoethylaminomethyl)tetramethyldisiloxane (AEAM, 0.1044 g, 0.375 mmol, 0.75 eq.) and dissolved in 5 mL toluene. Then, 0.160 g (0.5 mmol) of Mg₂(dobpdc) that was desolvated in a 120° C. vacuum oven overnight was added to the vial. The slurry was then stirred at 60° C. on a hot plate for 3 days at 300-400 rpm. The material was cooled to room temperature and transferred to a conical tube. The material was spun down at a rate of 4000 rpm for 2 minutes, the solvent was decanted and then resuspended in another 10 mL of toluene for 4-6 hours. It was centrifuged, decanted and dried in a 120° C. vacuum oven overnight to obtain 0.166 g of GE140 (64% yield, Mg₂(dobpdc)(spermidine)_{0.68} (AEAM)_{0.37}).

¹H NMR analysis was performed on the final material after digestion with 20 μL of 35% DC in D₂O, 200 μL of D₂O, and 600 μL of DMSO-d₆. ¹H NMR (DMSO-d₆, D₂O) δ 7.86 (dd, 2H), 7.69 (dd, 2H), 6.99 (dd, 2H), 3.22-3.16 (m, 2.96H), 2.97-2.78 (m, 5.44H), 2.38 (s. 1.48H) 1.92 (m, 1.36H), 1.61 (m, 2.72H), 0.17 (s, 4.44H).

### Example 8. Comparative Performance

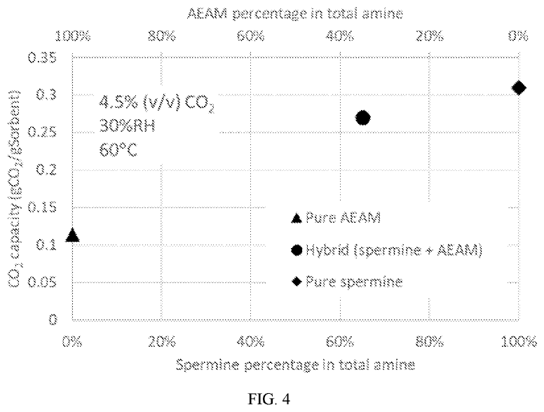

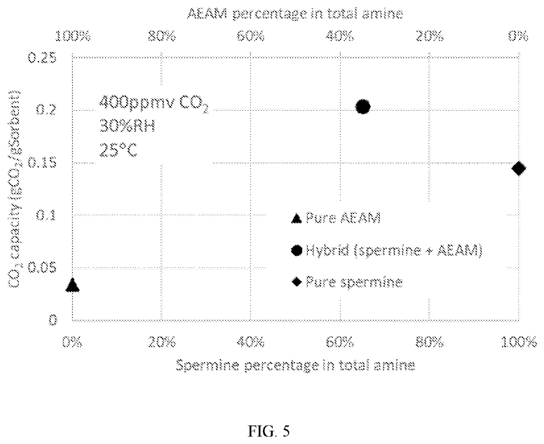

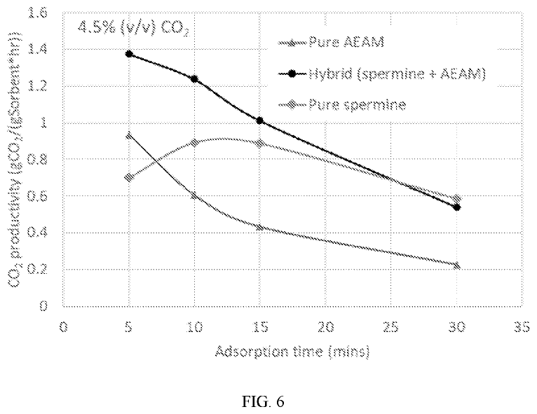

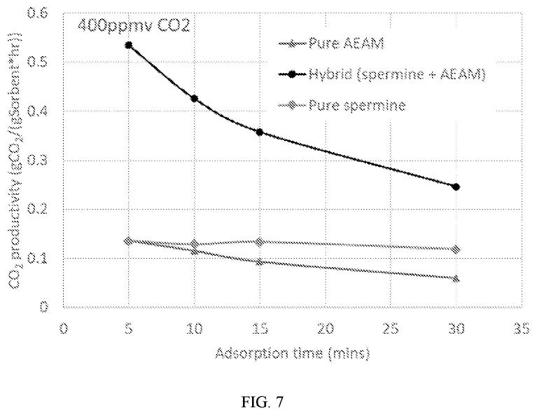

Equilibrium CO₂ capacity (g_{CO2} per g_{Sorbent}) of MOF sorbents functionalized with pure AEAM (such as MOF Compound 1), pure spermine (such as MOF Compound 3), and hybrid amines (such as MOF Compound 5) measured at 4.5% (v/v) CO₂ and 400 ppmv CO₂ as a function of spermine loading is shown in FIG. 4 and FIG. 5, respectively. 4.5% (v/v) corresponds to post-combustion capture (PCC) conditions, such as natural gas combined cycle post-combustion capture conditions, and 400 ppmv CO₂ corresponds to direct air capture (DAC) conditions. These figures illustrate that maximum CO₂ capacity increases as the spermine percentage increases for the PCC conditions having 4.5% (v/v) CO₂ (FIG. 4). Under DAC conditions having 400 ppmv CO₂, the hybrid amine-based sorbent exhibits higher capacity with respect to the two pure amine-based materials (FIG. 5). In addition, the CO₂ productivity with a unit of g_{CO2}/(g_{Sorbet}*hr), calculated by normalizing CO₂ uptake at a given cycle time, exhibits strong dependence on ligand selection. The hybrid amine sorbent MOF Compound 5 has significantly enhanced productivity compared to sorbents having either of the constituent amines for both PCC conditions (FIG. 6) and DAC conditions (FIG. 7).

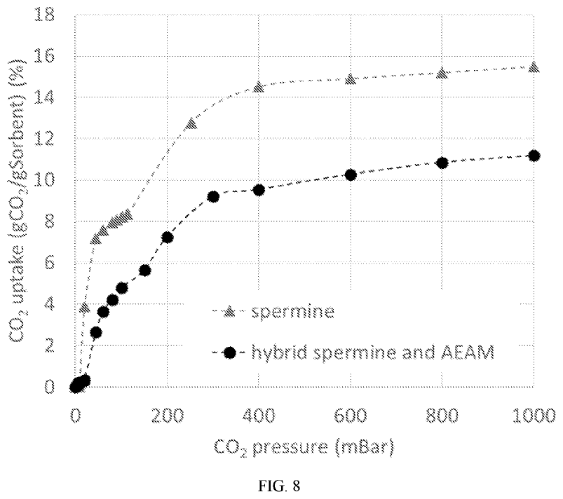

Further, the hybrid amine sorbent MOF Compound 5 has significantly reduced CO₂ uptake at elevated temperatures such as 120° C. (FIG. 8), suggesting easier regeneration compared to the pure spermine sorbent (such as MOF Compound 3).

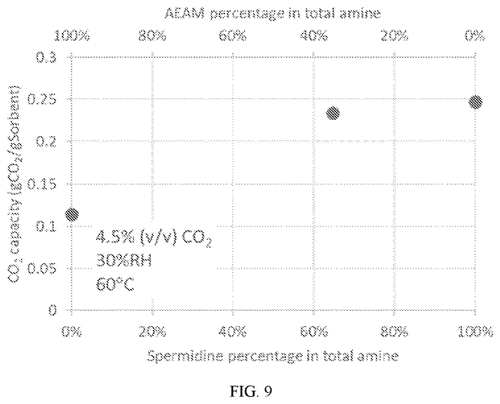

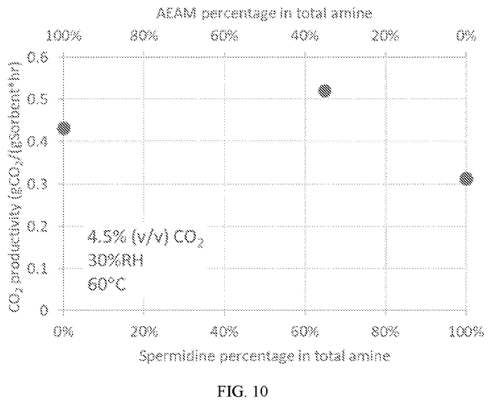

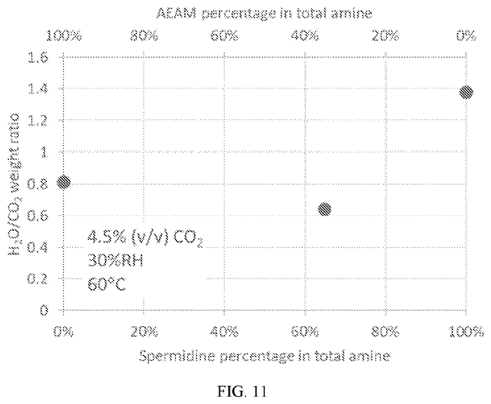

Similar improvements in performance are obtained for spermidine-based sorbent materials. Equilibrium CO₂ capacity and productivity of sorbent materials functionalized with pure AEAM (such as MOF Compound 1), pure spermidine (such as MOF Compound 4), and hybrid amines (such as MOF Compound 6) measured at 4.5% (v/v) CO₂ concentration as a function of spermidine loading are shown in FIG. 9 and FIG. 10, respectively. 4.5% (v/v) corresponds to post-combustion capture conditions (PCC conditions) and 400 ppmv CO₂ corresponds to direct air capture conditions (DAC conditions). These figures illustrate that maximum CO₂ capacity increases as the spermidine percentage increases for PCC conditions having 4.5% (v/v) CO₂ concentration. However, the hybrid amine sorbent MOF Compound 6 has the greatest productivities when compared to sorbents having either of the constituent amines. Furthermore, both sorbent materials including AEAM (such as MOF Compound 1 having pure AEAM and MOF Compound 6 having hybrid amines) exhibit a significantly reduced H₂O/CO₂ ratio compared to the pure spermidine sorbent (such as MOF Compound 4) (FIG. 11).

The significant advantages in functionalizing sorbents with at least one functionalization ligand including an aminosilicone group, and with optional further functionalization with at least one functionalization ligand not including an aminosilicone group, are described herein. The materials and methods of the present disclosure are broadly applicable to a wide variety of sorbents and functionalization ligands.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Although specific features of various embodiments of the invention may be shown in some drawings and not in others, this is for convenience only. Moreover, references to “some embodiments” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is readily understood by those skilled in the art that some substituents of the present disclosure depend on the presence of other substituents and are therefore optional. For example, in Formula II, when R₉ is a direct bond, R₁ and R₂ are optional substituents not present in the compound. Similarly, in Formula II, when n is 0, there is a direct bond between R₉ and R₁₀, and R₃, R₄, and R₁₁ are optional substituents not present in the compound. The optionality of a substituent in one embodiment is non-limiting regarding the presence of the substituent in another embodiment.

As used herein, the term “alkyl”, used either alone or in compound words such as “haloalkyl” includes straight-chain or branched alkyl such as methyl, ethyl, n-propyl and i-propyl, or the different butyl, pentyl or hexyl isomers. An alkyl defined by a number of carbon atoms, e.g. C₆ alkyl, is understood to have that many carbon atoms but is not otherwise limited.

As used herein, the term “heteroalkyl” denotes an alkyl chain wherein at least one of the atoms forming the chain backbone is other than carbon.

As used herein, “aminoalkyl” includes an N radical substituted with straight-chain or branched alkyl.

As used herein, the term “halogen” or “halide” either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The term “haloalkoxy”, and the like, are defined analogously to the term “haloalkyl”. Examples of “haloalkoxy” include CF₃O, CCl₃CH₂O, F₂CHCH₂CH₂O and CF₃CH₂O.

As used herein, the term “heterocycle” denotes a ring wherein at least one of the atoms forming the ring backbone is other than carbon. Unless otherwise indicated, a heterocycle can be a saturated, partially unsaturated, or fully unsaturated ring. When a fully unsaturated heterocyclic ring satisfies Hückel's rule, then said ring is also called a “heteroaryl” or aromatic heterocyclic ring. “Saturated heterocyclic ring” refers to a heterocyclic ring containing only single bonds between ring members.

As used herein, the term “aminosilicone group” includes functional groups that include both an amine group and a siloxane group (also called a disiloxane group) including a Si—O—Si linkage.

¹H NMR spectra are reported in ppm downfield from tetramethylsilane; “s” means singlet, “d” means doublet, “dd” means doublet of doublets, “ddd” means doublet of doublet of doublets, “t” means triplet, “m” means multiplet, and “br s” means broad singlet.

What is claimed is:

1. A functionalized sorbent comprising:
a sorbent; and
at least one functionalization ligand comprising an aminosilicone group.

2. The functionalized sorbent of claim 1, further comprising at least one functionalization ligand that does not comprise an aminosilicone group.

3. The functionalized sorbent of claim 2, wherein the at least one functionalization ligand comprising an aminosilicone group and the at least one functionalization ligand not comprising an aminosilicone group are present in a ratio in a range of from about 10:1 to about 1:10.

4. The functionalized sorbent of claim 1, wherein the sorbent is selected from the group consisting of coordination framework compounds, metal-organic framework (MOF) compounds, porous coordination polymers (PCPs), covalent organic framework (COF) compounds, zeolitic imidazolate framework (ZIF) compounds, crystalline porous materials, crystalline open frameworks, reticular chemistry, silica particles, zeolites, silico-alumino-phosphates (SAPOs), alumino-phosphates (AlPOs), polyaromatic frameworks (PAFs), activated carbons, molecular organic solids, and combinations thereof.

5. The functionalized sorbent of claim 1, wherein the functionalized sorbent is a functionalized MOF compound of Formula (I)
$${M}_{x} {L}_{y} {F}_{a}^{A} {F}_{b}^{B} , \qquad ( Formula I )$$
wherein:
M is a MOF metal or metal-containing cluster;
L is a MOF linker;
F^{A} is the at least one functionalization ligand comprising an aminosilicone group;
F^{B} is at least one functionalization ligand not comprising an aminosilicone group;
x is a value in a range of 1 to 6;
y is a value in a range of 1 to 6;
a is a value greater than 0 and less than or equal to 2; and
b is a value in a range of 0 to 2.

6. The functionalized sorbent of claim 5, wherein the MOF metal or metal-containing cluster comprises a metal selected from the group consisting of alkali metals, alkaline earth metals, transition metals, Mg, Ca, Mn, Cr, Fe, Co, Ni, Cu, Zn, ions thereof, hydrates thereof, salts thereof, halides thereof, fluorides thereof, chlorides thereof, bromides thereof, iodides thereof, nitrates thereof, acetates thereof, sulfates thereof, phosphates thereof, carbonates thereof, oxides thereof, formates thereof, carboxylates thereof, and combinations thereof.

7. The functionalized sorbent of claim 5, wherein the MOF linker comprises a linker selected from the group consisting of polytopic linkers, 4,4′-dihydroxy-[1,1′-biphenyl]-3,3′-dicarboxylic acid (H₄dobpdc), 4,4′-dioxidobiphenyl-3,3′-dicarboxylate (dobpdc⁴⁻), 4,4″-dioxido-[1,1′:4′,1″-terphenyl]-3,3″-dicarboxylate (dotpdc⁴⁻), 2,5-dioxidobenzene-1,4-dicarboxylate (dobdc⁴⁻), 4,6-Dihydroxyisophthalic acid (m-dobdc⁴⁻), 3,3′-dioxido-biphenyl-4,4′-dicarboxylate (para-carboxylate-dobpdc⁴⁻), 4,4′-[oxalylbis(imino)]bis(2-hydroxybenzoic acid) (H₄ODA), 4,4′-[1,4-phenylenebis-(carbonylimino)]bis(2-hydroxybenzoic acid) (H₄TDA), 4,4′-Dihydroxyazobenzene-3,3′-dicarboxylic acid (H₄OSA), dicarboxylates, terephthalic acid, tricarboxylates, 1,3,5-benzentricarboxylic acid, azolates, tetrazolates, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octanedicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis-(phenylamino)benzene-2,5-dicarboxylic acid, 1,1′-dinaphthyl-8,8′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro) phenylpyrazoline-4,5-dicarboxylic acid, 1,4,5,6,7,7,-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cisdicarboxylic acid, 2,2′-biquinoline-4,4′-dicarboxylic acid, pyridine-3,4-dicarboxylic acid, 3,6,9-trioxaundecanedicarboxylic acid, o-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyletherdiimidedicarboxylic acid, 4,4′-diaminodiphenylmethanediimidedicarboxylic acid, 4,4′-diaminodiphenylsulfonediimidedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′-3′-diphenyl-p-terphenyl-4,4″-dicarboxylic acid, diphenylether-4,4′-dicarboxylic acid, imidazole-4,5-dicarboxylic acid, 4(1H)-oxothiochromene-2,8-dicarboxylic acid, 5-t-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptanedicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, aurinetricarboxylic acid, 1,1-dioxide-perylo[1,12-BCD]thiophene-3,4,9,10-tetracarboxylic acid, perylenetetracarboxylic acids, perylene-3,4,9,10-tetracarboxylic acid, perylene-1,12-sulfone-3,4,9,10-tetracarboxylic acid, butanetetracarboxylic acids, 1,2,3,4-butanetetracarboxylic acid, meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, cyclopentanetetracarboxylic acids, cyclopentane-1,2,3,4-tetracarboxylic acid, polytopic linkers, ditopic linkers, tritopic linkers, tetratopic linkers, pentatopic linkers, hexatopic linkers, heptatopic linkers, octatopic linkers, mixed linkers, desymmetrized linker, metallo linkers, N-heterocyclic linkers, protonated, partially and fully deprotonated forms thereof, and combinations thereof.

8. The functionalized sorbent of claim 1, wherein the at least one functionalization ligand comprising an aminosilicone group comprises at least one amine selected from the group consisting of primary amines, secondary amines, tertiary amines, and combinations thereof.

9. The functionalized sorbent of claim 1, wherein the at least one functionalization ligand comprising an aminosilicone group comprises at least one amine selected from the group consisting of monoamines, diamines, triamines, tetra-amines, penta-amines, hexa-amines, polyamines, and combinations thereof.

10. The functionalized sorbent of claim 1, wherein the at least one functionalization ligand comprising an aminosilicone group comprises at least one aminosilicone selected from the group consisting of linear aminosilicones, cyclic aminosilicones, branched aminosilicones, amino-substituted siloxanes, linear amino-substituted disiloxanes, cyclic amino-substituted disiloxanes, linear amino-substituted trisiloxanes, cyclic amino-substituted trisiloxanes, linear amino-substituted tetrasiloxanes, cyclic amino-substituted tetrasiloxanes, linear amino-substituted polysiloxanes, cyclic amino-substituted polysiloxanes, silsesquioxanes, polyoctahedral silsesquioxanes, and combinations thereof.

11. The functionalized sorbent of claim 1, wherein the at least one functionalization ligand comprising an aminosilicone group comprises a symmetrical structure.

12. The functionalized sorbent of claim 1, wherein the at least one functionalization ligand comprising an aminosilicone group comprises an asymmetrical structure.

13. The functionalized sorbent of claim 1, wherein the at least one functionalization ligand comprising an aminosilicone group is an amino-substituted siloxane of Formula (II), Formula (III), Formula (IV), Formula (V), Formula (VI), or Formula (VII) 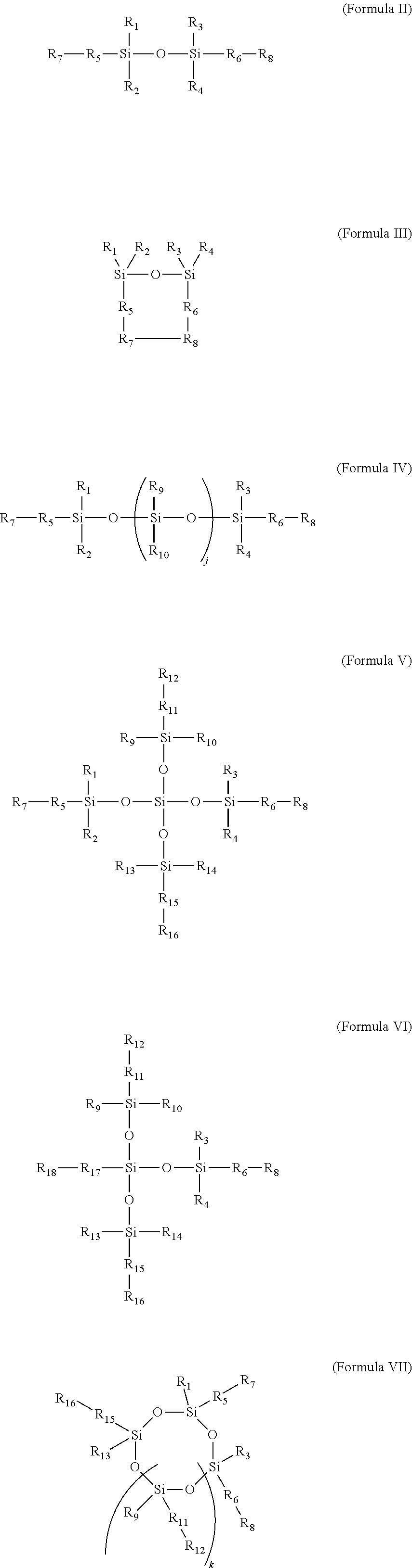
wherein:
R₁, R₂, R₃, R₄, R₉, R₁₀, R₁₃, R₁₄, and R₁₈ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₅, R₆, R₁₁, R₁₅, and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl,
R₇, R₈, R₁₂, and R₁₆ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, and substituents of Formula (VIII) 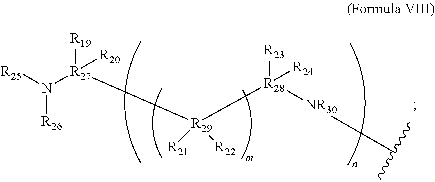
wherein:
the wavy bond indicates a bonding location to Formula (II) or Formula (III) or Formula (IV) or Formula (V) or Formula (VI) or Formula (VII);
R₁₉, R₂₀, R₂₁, R₂₂, R₂₃, and R₂₄ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₂₅ and R₂₆ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₂₅ and R₂₆ form a single ring selected from the group consisting of heterocycloalkyl and heteroaryl;
R₂₇, R₂₈, and R₂₉ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₀ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl;
j is an integer in a range of 0 to 20;
k is an integer in a range of 0 to 20;
m is an integer in a range of 0 to 20; and
n is an integer in a range of 0 to 20.

14. The functionalized sorbent of claim 1, wherein the at least one functionalization ligand comprising an aminosilicone group is selected from the group consisting of

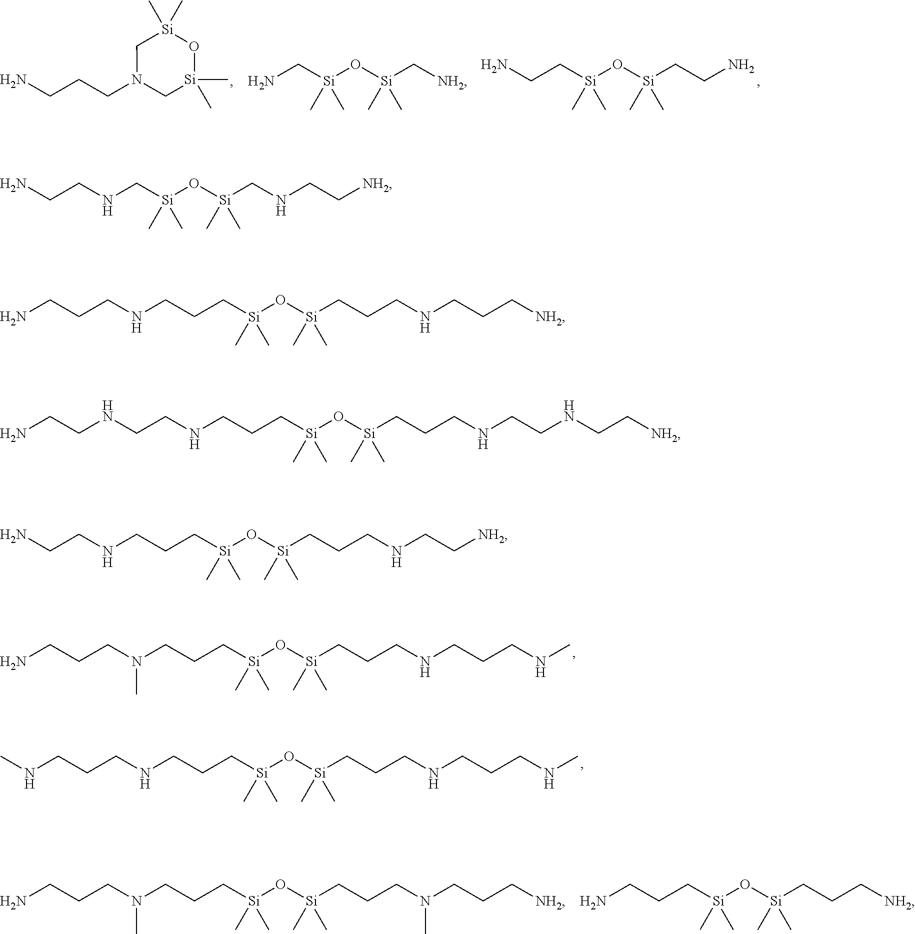

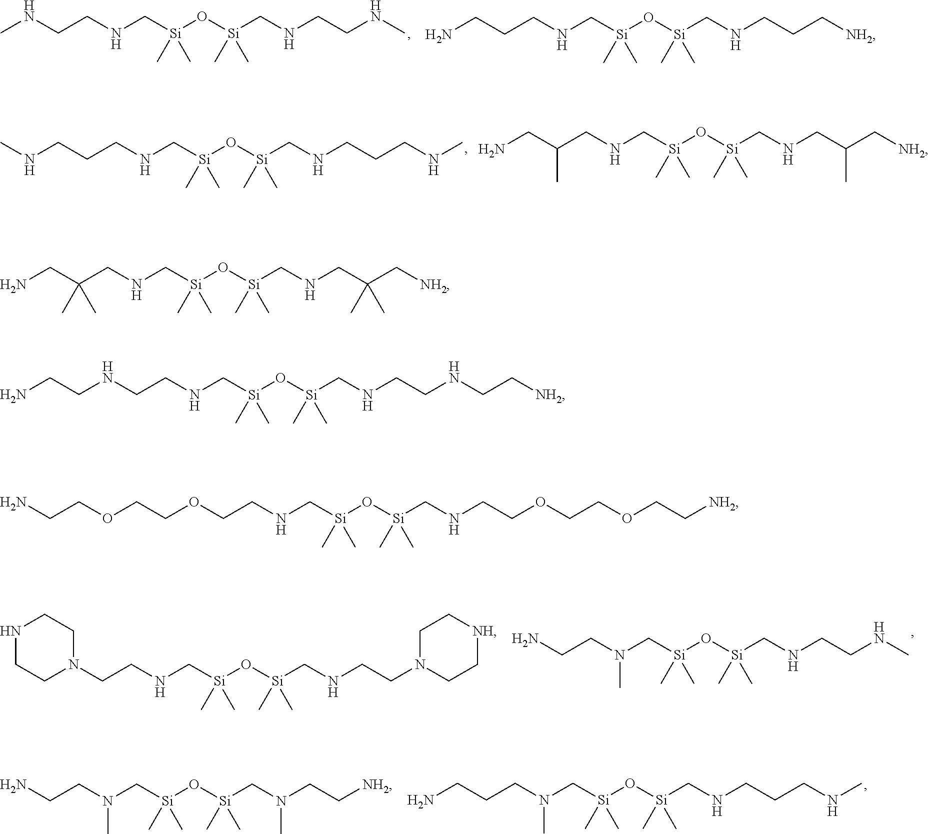

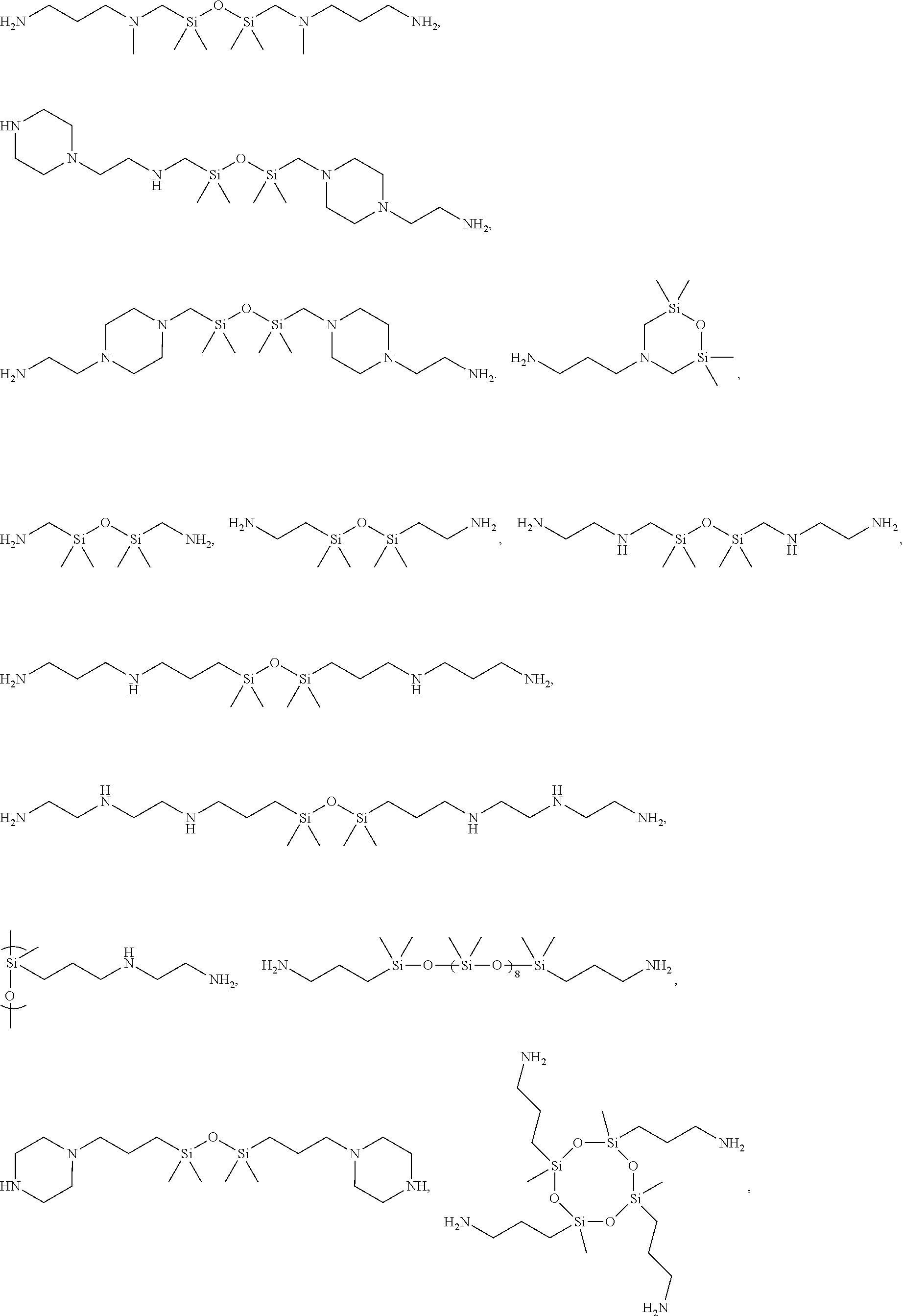

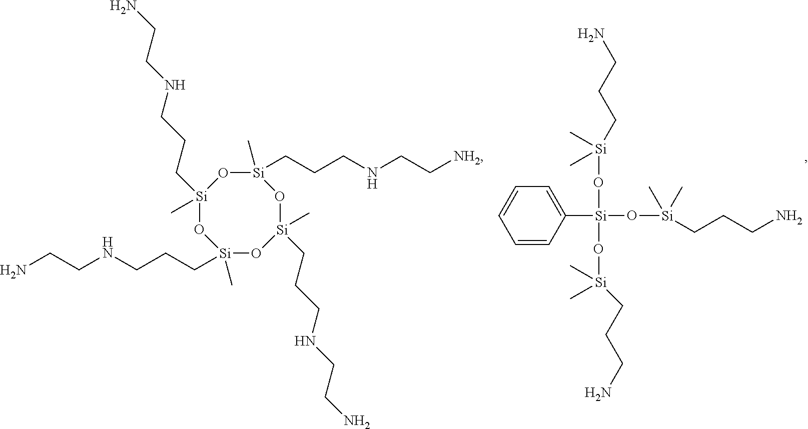 [SMILES: C[Si]1(CCCNCCN)O[Si](C)(CCCNCCN)O[Si](C)(CCCNCCN)O[Si](C)(CCCNCCN)O1 ; C[Si](C)(CCCN)O[Si](O[Si](C)(C)CCCN)(O[Si](C)(C)CCCN)c1ccccc1]

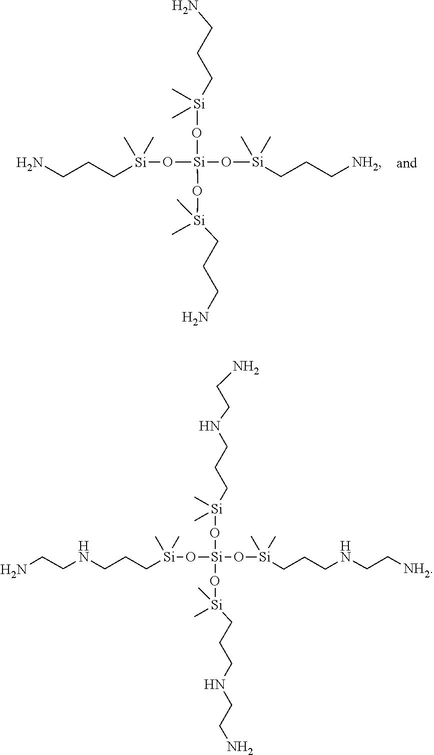 [SMILES: C[Si](C)(CCCN)O[Si](O[Si](C)(C)CCCN)(O[Si](C)(C)CCCN)O[Si](C)(C)CCCN ; C[Si](C)(CCCNCCN)O[Si](O[Si](C)(C)CCCNCCN)(O[Si](C)(C)CCCNCCN)O[Si](C)(C)CCCNCCN]

15. A sorbent system comprising the functionalized sorbent of claim 1.

16. A method of making a functionalized sorbent, the method comprising:
(I) forming a mixture comprising:
a sorbent;
at least one functionalization ligand including an aminosilicone group;
optionally at least one functionalization ligand not including an aminosilicone group;
optionally a solvent; and
and optionally a non-solvent; and
(II) functionalizing the sorbent.

17. A method of capturing at least one gas, the method comprising:
(I) receiving a gas source comprising the at least one gas at a functionalized sorbent, wherein the functionalized sorbent comprises:
a sorbent; and
at least one functionalization ligand comprising an aminosilicone group; and
(II) capturing an amount of the at least one gas with the functionalized sorbent.

18. The method of claim 17, wherein the gas source is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

19. The method of claim 17, wherein the at least one gas is selected from the group consisting of air, flue gas, post-combustion gas, natural gas, syngas, carbon dioxide, carbon monoxide, water vapor, hydrogen, nitrogen, oxygen, methane, olefin gases, and combinations thereof.

20. A method of collecting at least one gas from a gas source, the method comprising:
capturing the at least one gas according to the method of claim 17, and
(III) releasing the at least one gas from the functionalized sorbent.
